(19) United States
(12) Patent Application Publication
(10) Pub. No.: US 2026/0120279 A1
(43) Pub. Date: Apr. 30, 2026

(54) METHODS, SYSTEMS, AND DEVICES FOR UNSUPERVISED TRAINING USING REAL-TIME MEDICAL VIDEO DATA

(71) Applicant: Stryker Corporation, Portage, MI (US)

(72) Inventors: Bhavya Nishitkumar AJANI, Bengaluru (IN); Ramanan PARAMASIVAN, San Jose, CA (US)

(73) Assignee: Stryker Corporation, Portage, MI (US)

(21) Appl. No.: 19/367,593

(22) Filed: Oct. 23, 2025

Related U.S. Application Data
(60) Provisional application No. 63/711,344, filed on Oct. 24, 2024.

(51) Int. Cl. G06T 7/00; G06T 3/40; G06V 20/70

(52) U.S. Cl. CPC G06T 7/0012; G06T 3/40; G06V 20/70; G06T 2207/20081

(57) ABSTRACT

A system obtains a first portion of real-time medical video data and creates first training data using the first portion of real-time medical video data. The system trains a machine learning model for a pretext task based on the first training data, using a training program of a computer. The system obtains a second portion of the real-time medical video data and replaces, in a memory of the computer, at least a subset the first portion of the real-time medical video data with the second portion of the real-time medical video data. The memory is accessible only by the training program. The system creates second training data for the pretext task using the second portion of the real-time medical video data and trains the machine learning model for the pretext task based on the second training data, using the training program of the computer.

### CROSS-REFERENCE TO RELATED APPLICATIONS

This application claims the benefit of U.S. Provisional Application No. 63/711,344, filed Oct. 24, 2024, the entire contents of which are hereby incorporated by reference herein.

### FIELD

The present disclosure relates to unsupervised machine learning, and more specifically to unsupervised training of machine learning models using real-time medical data.

### BACKGROUND

Deep learning models require massive quantities of training data. However, medical data of medical procedures, such as surgical procedures, that is available for training machine learning models remains scarce. A major challenge in acquiring surgical videos at scale is the reluctance of healthcare professionals to record surgical videos due to medico-legal concerns, patient privacy concerns, and/or lack of infrastructure for storage of such massive quantities of data. Lacking the infrastructure for such massive quantities of training data, the potential of machine learning for improved outcomes in the medical field is hindered.

### SUMMARY

Disclosed herein are systems, devices, and methods that enable training of robust and accurate machine learning models using real-time medical data, including real-time medical video data. The systems, devices, and methods disclosed herein use real-time streams of medical data captured during medical procedures and do not rely on retaining the medical data after it is used to train the model. In some aspects, portions of the real-time medical data may be temporarily held in memory while they are used to train the machine learning model. As more recent portions of the real-time medical data are received, the more recent portions replace the older portions, and the older portions are erased. Moreover, only the training program used to train the machine learning model may have access to the memory. Thus, the training techniques disclosed herein preserve patient privacy and mitigate concerns of healthcare professionals regarding recording data associated with surgical or other medical procedures. The systems, devices, and methods disclosed herein require significantly less data storage and management than conventional systems because the video data used for previous training are replaced in memory with more recent video data during current training. The real-time video data may be used to train the machine learning models disclosed herein for a variety of pretext tasks (e.g., unsupervised or self-supervised machine learning tasks), such as image reconstruction, event sequencing, and contrastive learning, among others. The trained machine learning models may be used to assist healthcare professionals by analyzing and/or enhancing real-time video that may be acquired during a medical procedure. Optionally, the machine learning models can be fine-tuned for downstream tasks such as object recognition using labeled training data.

According to some aspects, a computer implemented method for training a machine learning model based on real-time medical video data from a medical procedure, the method comprising: obtaining a first portion of the real-time medical video data; creating first training data for a pretext task, comprising processing the first portion of the real-time medical video data; training the machine learning model for the pretext task based on the first training data, using a training program of the computer; obtaining a second portion of the real-time medical video data; replacing, in a memory of the computer, at least a subset the first portion of the real-time medical video data with the second portion of the real-time medical video data, wherein the memory is accessible only by the training program; creating second training data for the pretext task, comprising processing the second portion of the real-time medical video data; and training the machine learning model for the pretext task based on the second training data, using the training program of the computer.

Optionally, the first portion of the real-time medical video data and the second portion of the real-time medical video data are inaccessible after the medical procedure ends. Optionally, the memory of the computer is a volatile memory. Optionally, replacing, in the memory of the computer, the first portion of the real-time medical video data with the second portion of the real-time medical video data comprises: overwriting, in the memory, the first portion of the real-time medical video data with the second portion of the real-time medical video data.

Optionally, processing the first portion of the real-time medical video data comprises: generating first modified data, comprising introducing noise into one or more frames of the first portion of the real-time medical video data, wherein the first training data comprises the first modified data. Optionally, processing the first portion of the real-time medical video data comprises: creating one or more frames comprising one or more masked pixels, comprising applying an image mask to one or more frames of the first portion of the real-time medical video data, wherein the first training data comprises the one or more frames comprising one or more masked pixels. Optionally, processing the first portion of the real-time medical video data to create the first training data comprises: creating one or more low-resolution frames, comprising reducing an image resolution of one or more frames of the first portion of the real-time medical video data, wherein the first training data comprises the one or more low-resolution frames. Optionally, processing the first portion of the real-time medical video data comprises: creating one or more low-quality frames, comprising reducing an image quality of one or more frames of the first portion of the real-time medical video data, wherein the first training data comprises the one or more low-quality frames. Optionally, processing the first portion of the real-time medical video data comprises: creating a temporally modified sequence of frames, comprising rearranging a sequence of frames of the first portion of the real-time medical video data, wherein the first training data comprises the temporally modified sequence of frames. Optionally, processing the first portion of the real-time medical video data comprises: creating at least one set of temporally adjacent frames and at least one set of temporally distant frames, comprising identifying at least two temporally adjacent frames of a plurality of frames of the first portion of the real-time medical video data and at least two temporally distant frames of the plurality of frames of the first portion of the real-time medical video data, wherein the first training data comprises the at least one set of temporally adjacent frames and the at least one set of temporally distant frames.

Optionally, processing the second portion of the real-time medical video data comprises: generating second modified data, comprising introducing noise into one or more frames from the second portion of the real-time medical video data, wherein the second training data comprises the second modified data. Optionally, processing the second portion of the real-time medical video data comprises: creating one or more frames comprising one or more masked pixels, comprising applying an image mask to one or more frames of the second portion of the real-time medical video data, wherein the second training data comprises the one or more frames comprising one or more masked pixels. Optionally, processing the second portion of the real-time medical video data to create the second training data comprises: creating one or more low-resolution frames, comprising reducing an image resolution of one or more frames of the second portion of the real-time medical video data, wherein the second training data comprises the one or more low-resolution frames. Optionally, processing the second portion of the real-time medical video data comprises: creating one or more low-quality frames, comprising reducing an image quality of one or more frames of the second portion of the real-time medical video data, wherein the second training data comprises the one or more low-quality frames. Optionally, processing the second portion of the real-time medical video data comprises: creating a temporally modified sequence of frames, comprising rearranging a sequence of the frames of the first portion of the real-time medical video data, wherein the second training data comprises the temporally modified sequence of frames. Optionally, processing the second portion of the real-time medical video data comprises: creating at least one set of temporally adjacent frames and at least one set of temporally distant frames, comprising identifying at least two temporally adjacent frames of a plurality of frames of the second portion of the real-time medical video data and at least two temporally distant frames of the plurality of frames of the second portion of the real-time medical video data, wherein the second training data comprises the at least one set of temporally adjacent frames and the at least one set of temporally distant frames.

Optionally, training the machine learning model for the pretext task based on the first training data comprises: generating first modified data, comprising introducing noise into one or more frames from the first portion of the real-time medical video data, wherein the first training data comprises the first modified data; inputting the first modified data into the machine learning model; and training the machine learning model for the pretext task based on the one or more frames of the first portion of the real-time medical video data and the first modified data.

Optionally, the pretext task comprises an image reconstruction pretext task and wherein training the machine learning model for the pretext task based on the first training data comprises: creating one or more frames comprising one or more masked pixels, comprising applying an image mask to one or more frames of the first portion of the real-time medical video data, wherein the first training data comprises the one or more frames comprising one or more masked pixels; training the machine learning model to reconstruct image data comprising one or more masked pixels, comprising inputting the one or more frames comprising one or more masked pixels into the machine learning model.

Optionally, the pretext task comprises an image reconstruction pretext task and wherein training the machine learning model for the pretext task based on the first training data comprises: creating one or more low-resolution frames, comprising reducing an image resolution of one or more frames of the first portion of the real-time medical video data, wherein the first training data comprises the one or more low-resolution frames; and training the machine learning model to reconstruct a high-resolution frame based on low-resolution image data, comprising inputting the one or more low-resolution frames into the machine learning model.

Optionally, the pretext task comprises an image reconstruction pretext task and wherein training the machine learning model for the pretext task based on the first training data comprises: creating one or more low-quality frames, comprising reducing an image quality of one or more frames of the first portion of the real-time medical video data, wherein the first training data comprises the one or more low-quality frames; and training the machine learning model to reconstruct a high-quality frame based on low-quality image data, comprising inputting the one or more low-quality frames into the machine learning model.

Optionally, the pretext task comprises an event sequencing pretext task, and wherein training the machine learning model for the pretext task based on the first training data comprises: creating a temporally modified sequence of frames, comprising rearranging a sequence of frames of the first portion of the real-time medical video data, wherein the first training data comprises the temporally modified sequence of frames; and training the machine learning model to construct an ordered sequence of image data, comprising inputting the temporally modified sequence of frames into the machine learning model.

Optionally, the pretext task comprises a contrastive temporal distance pretext task and wherein training the machine learning model for the pretext task based on the first training data comprises: creating at least one set of temporally adjacent frames and at least one set of temporally distant frames, comprising identifying at least two temporally adjacent frames of a plurality of frames of the first portion of the real-time medical video data and at least two temporally distant frames of the plurality of frames of the first portion of the real-time medical video data, wherein the first training data comprises the at least one set of temporally adjacent frames and the at least one set of temporally distant frames; and training the machine learning model to identify temporal relationships in time-series image data, comprising inputting the at least one set of temporally adjacent frames and the at least one set of temporally distant frames into the machine learning model.

Optionally, training the machine learning model for the pretext task based on the second training data comprises: generating second modified data, comprising introducing noise into one or more frames from the second portion of the real-time medical video data, wherein the second training data comprises the second modified data; inputting the second modified data into the machine learning model; and training the machine learning model for the pretext task based on the one or more frames from the second portion of the real-time medical video data and the second modified data.

Optionally, the pretext task comprises an image reconstruction pretext task and wherein training the machine learning model for the pretext task based on the second training data comprises: creating one or more frames comprising one or more masked pixels, comprising applying an image mask to one or more frames of the second portion of the real-time medical video data, wherein the second training data comprises the one or more frames comprising one or more masked pixels; training the machine learning model to reconstruct image data comprising one or more masked pixels comprising inputting the one or more frames comprising one or more masked pixels into the machine learning model.

Optionally, the pretext task comprises an image reconstruction pretext task and wherein training the machine learning model for the pretext task based on the second training data comprises: creating one or more low-resolution frames, comprising reducing an image resolution of one or more frames of the second portion of the real-time medical video data, wherein the second training data comprises the one or more low-resolution frames; and training the machine learning model to reconstruct a high-resolution frame based on low-resolution image data, comprising inputting the one or more low-resolution frames into the machine learning model.

Optionally, the pretext task comprises an image reconstruction pretext task and wherein training the machine learning model for the pretext task based on the second training data comprises: creating one or more low-quality frames, comprising reducing an image quality of one or more frames of the second portion of the real-time medical video data, wherein the second training data comprises the one or more low-quality frames; and training the machine learning model to reconstruct a high-quality frame based on low-quality image data, comprising inputting the one or more low-quality frames into the machine learning model.

Optionally, the pretext task comprises an event sequencing pretext task, and wherein training the machine learning model for the pretext task based on the second training data comprises: creating a temporally modified sequence of frames, comprising rearranging a sequence of frames of the second portion of the real-time medical video data, wherein the second training data comprises the temporally modified sequence of frames; and training the machine learning model to construct an ordered sequence of image data, comprising inputting the temporally modified sequence of frames into the machine learning model.

Optionally, the pretext task comprises a contrastive temporal distance pretext task and wherein training the machine learning model for the pretext task based on the second training data comprises: creating at least one set of temporally adjacent frames and at least one set of temporally distant frames, comprising identifying at least two temporally adjacent frames of a plurality of frames of the second portion of the real-time medical video data and at least two temporally distant frames of the plurality of frames of the second portion of the real-time medical video data, wherein the second training data comprises the at least one set of temporally adjacent frames and the at least one set of temporally distant frames; and training the machine learning model to identify temporal relationships in time-series image data, comprising inputting the at least one set of temporally adjacent frames and the at least one set of temporally distant frames into the machine learning model.

Optionally, the method includes retraining the machine learning model using labeled image data for one or more downstream tasks associated with the pretext task. Optionally, the method includes retraining the machine learning model using labeled image data for one or more downstream tasks associated with the pretext task, wherein the labeled image data for the one or more downstream tasks associated with the pretext task comprises labeled surgical image data obtained during a surgical procedure. Optionally, the method includes retraining the machine learning model using labeled image data for one or more downstream tasks associated with the pretext task, wherein the one or more downstream tasks comprises: a semantic segmentation downstream task, wherein the semantic segmentation downstream task comprises detecting one or more anatomical features in image data of a surgical procedure, wherein the semantic segmentation downstream task is associated with an image reconstruction pretext task. Optionally, the method includes retraining the machine learning model using labeled image data for one or more downstream tasks associated with the pretext task, wherein the one or more downstream tasks comprises: an action recognition downstream task, wherein the action recognition downstream task comprises classifying an action detected based on image data of a surgical procedure, wherein the action recognition downstream task is associated with an event sequencing pretext task. Optionally, the method includes retraining the machine learning model using labeled image data for one or more downstream tasks associated with the pretext task, wherein the one or more downstream tasks comprises: a phase recognition downstream task, wherein the phase recognition task comprises classifying a surgical procedure phase based on image data of a surgical procedure, wherein the phase recognition downstream task is associated with a contrastive temporal distance pretext task.

Optionally, the real-time medical video data is captured by an endoscopic imaging system. Optionally, the machine learning model comprises a transformer model. Optionally, the machine learning model comprises a convolutional neural network. Optionally, the machine learning model is trained for the pretext task using unsupervised learning. Optionally, the method includes inputting real-time medical video data into the machine learning model trained for the pretext task; generating an output, comprising enhancing a resolution of the real-time medical video data; and causing display of the output. Optionally, the method includes inputting real-time medical video data into the machine learning model trained for the pretext task; generating an output, comprising enhancing a quality of the real-time medical video data; and causing display of the output.

Optionally, the method includes retraining the machine learning model trained for the pretext task to generate segmentation masks based on real-time medical video data; inputting real-time medical video data into the machine learning model retrained to generate segmentation masks; generating a segmentation mask based on the real-time medical video data; generating an output, comprising overlaying the segmentation mask on the real-time medical video data; and causing display of the output. Optionally, the method includes retraining the machine learning model trained for the pretext task to classify surgical actions based on real-time medical video data; inputting real-time medical video data into the machine learning model retrained to classify surgical actions; classifying a surgical action based on the real-time medical video data; generating an output, comprising the classified surgical action; and causing display of the output. Optionally, the method includes retraining the machine learning model trained for the pretext task to classify surgical phases based on real-time medical video data; inputting real-time medical video data into the machine learning model retrained to classify surgical phases; classifying a surgical phase based on the real-time medical video data; generating an output, comprising the classified surgical phase; and causing display of the output. According to an aspect, a machine learning model is trained according to any of the methods disclosed herein.

According to an aspect, a system for training a machine learning model based on real-time medical video data from a medical procedure comprises one or more processors and a memory storing one or more programs that include instructions executable by the one or more processors for causing the system to: obtain a first portion of the real-time medical video data; create first training data for a pretext task, comprising processing the first portion of the real-time medical video data; train the machine learning model for the pretext task based on the first training data, using a training program; obtain a second portion of the real-time medical video data; replace, in a memory of the system, at least a subset the first portion of the real-time medical video data with the second portion of the real-time medical video data, wherein the memory is accessible only by the training program; create second training data for the pretext task, comprising processing the second portion of the real-time medical video data; and train the machine learning model for the pretext task based on the second training data, using the training program.

Optionally, the memory is a volatile memory. Optionally, the first portion of the real-time medical video data and the second portion of the real-time medical video data are inaccessible after the medical procedure ends. Optionally, the system comprises one or more imaging devices configured to capture the real-time medical video data. Optionally, the one or more imaging devices comprise any of an endoscopic imaging device, a pan-tilt-zoom (PTZ) camera, an open-field imaging device, and an in-light camera (ILC).

According to an aspect, a non-transitory computer-readable storage medium stores instructions for training a machine learning model based on real-time medical video data from a medical procedure, the instructions executable by a system comprising one or more processors to cause the system to: obtain a first portion of the real-time medical video data; create first training data for a pretext task, comprising processing the first portion of the real-time medical video data; train the machine learning model for the pretext task based on the first training data, using a training program; obtain a second portion of the real-time medical video data; replace, in a memory of the system, at least a subset the first portion of the real-time medical video data with the second portion of the real-time medical video data, wherein the memory is accessible only by the training program; create second training data for the pretext task, comprising processing the second portion of the real-time medical video data; and train the machine learning model for the pretext task based on the second training data, using the training program.

According to an aspect, a method for creating a foundation machine learning model using federated machine learning comprises: receiving, at a computing system from a first computing device, model variables of a first machine learning model trained based on unlabeled image data obtained from first real-time medical video data for at least one pretext task, wherein the first real-time medical video data comprises video data captured during a first medical procedure; receiving, at the computing system from a second computing device, model variables of a second machine learning model trained based on unlabeled image data obtained from second real-time medical video data for the at least one pretext task, wherein the second real-time medical video data comprises video data captured during a second medical procedure, wherein: a memory of the first computing device storing the unlabeled image data obtained from the first real-time medical video data is accessible only by a training program for training the first machine learning model and is accessible only during the first medical procedure, and a memory of the second computing device storing the unlabeled image data obtained from the second real-time medical video data is accessible only by a training program for training the second machine learning model and is accessible only during the second medical procedure; and aggregating the model variables of at least the first machine learning model and the second machine learning model to create the foundation machine learning model.

Optionally, the memory of the first computing device is a volatile memory. Optionally, the memory of the second computing device is a volatile memory. Optionally, the unlabeled image data obtained from the first real-time medical video data is not received at the computing system, and wherein the unlabeled image data obtained from the second real-time medical video data is not received at the computing system. Optionally, no patient identifying information associated with the first real-time medical video data or the second real-time medical video data is received at the computing system.

Optionally, the at least one pretext task comprises a plurality of pretext tasks. Optionally, the at least one pretext task comprises: an image reconstruction pretext task, the image reconstruction task comprising reconstruction of high-quality image data based on low-quality image data. Optionally, the at least one pretext task comprises: an image reconstruction pretext task, the image reconstruction task comprising reconstruction of high-resolution image data based on low-resolution image data. Optionally, the at least one pretext task comprises: an image reconstruction pretext task, the image reconstruction task comprising reconstruction of unmasked image data based on masked image data. Optionally, the at least one pretext task comprises: an event sequencing pretext task, the event sequencing pretext task comprising reconstruction of an ordered sequence of image data. Optionally, the at least one pretext task comprises: a contrastive temporal distance pretext task, the contrastive temporal distance pretext task comprising identification of one or more temporally adjacent portions of image data in a time series of image data and one or more temporally distant portions of image data in a time series of image data.

Optionally, the method includes retraining the foundation machine learning model using labeled image data for one or more downstream tasks associated with the at least one pretext task. Optionally, the method includes retraining the foundation machine learning model using labeled image data for one or more downstream tasks associated with the at least one pretext task, wherein: the labeled image data for the one or more downstream tasks associated with the at least one pretext task comprises labeled surgical image data obtained during a surgical procedure. Optionally, the method includes retraining the foundation machine learning model using labeled image data for one or more downstream tasks associated with the at least one pretext task, wherein the one or more downstream tasks comprises: a semantic segmentation downstream task, wherein the semantic segmentation downstream task comprises detection of one or more anatomical features in image data of a surgical procedure, wherein the semantic segmentation downstream task is associated with an image reconstruction pretext task. Optionally, the method includes retraining the foundation machine learning model using labeled image data for one or more downstream tasks associated with the at least one pretext task, wherein the one or more downstream tasks comprises: an action recognition downstream task, wherein the action recognition downstream task comprises classification of an action detected based on image data of a surgical procedure, wherein the action recognition downstream task is associated with an event sequencing pretext task. Optionally, the method includes retraining the foundation machine learning model using labeled image data for one or more downstream tasks associated with the at least one pretext task, wherein the one or more downstream tasks comprises: a phase recognition downstream task, wherein the phase recognition task comprises classification of a surgical procedure phase based on image data of a surgical procedure, wherein the phase recognition downstream task is associated with a contrastive temporal distance pretext task.

Optionally, the method includes transmitting the foundation machine learning model to the first computing device and the second computing device. Optionally, the method includes transmitting model variables of the foundation machine learning model to the first computing device and the second computing device; retraining the foundation machine learning model for the at least one pretext task at the first computing device; retraining the foundation machine learning model for the at least one pretext task at the second computing device; receiving model variables of the foundation machine learning model retrained for the at least one pretext task from the first computing device; receiving model variables of the foundation machine learning model retrained for the at least one pretext task from the second computing device; and aggregating the model variables of the foundation machine learning model retrained for the at least one pretext task from the first computing device and the model variables of the foundation machine learning model retrained for the at least one pretext task from the second computing device to create an updated foundation machine learning model. Optionally, the method includes transmitting model variables of the foundation machine learning model to the first computing device and the second computing device; retraining the foundation machine learning model for the at least one pretext task at the first computing device; retraining the foundation machine learning model for the at least one pretext task at the second computing device; receiving model variables of the foundation machine learning model retrained for the at least one pretext task from the first computing device; receiving model variables of the foundation machine learning model retrained for the at least one pretext task from the second computing device; and aggregating the model variables of the foundation machine learning model retrained for the at least one pretext task from the first computing device and the model variables of the foundation machine learning model retrained for the at least one pretext task from the second computing device to create an updated foundation machine learning model, wherein retraining the foundation machine learning model for the at least one pretext task at the first computing device comprises retraining the foundation machine learning model based on a third real-time medical video data.

Optionally, the method includes transmitting model variables of the foundation machine learning model to the first computing device and the second computing device; retraining the foundation machine learning model for the at least one pretext task at the first computing device; retraining the foundation machine learning model for the at least one pretext task at the second computing device; receiving model variables of the foundation machine learning model retrained for the at least one pretext task from the first computing device; receiving model variables of the foundation machine learning model retrained for the at least one pretext task from the second computing device; and aggregating the model variables of the foundation machine learning model retrained for the at least one pretext task from the first computing device and the model variables of the foundation machine learning model retrained for the at least one pretext task from the second computing device to create an updated foundation machine learning model, wherein retraining the foundation machine learning model for the at least one pretext task comprises retraining the foundation machine learning model based on a fourth real-time medical video data.

Optionally, the first machine learning model was trained for the at least one pretext task by: obtaining a first portion of the first real-time medical video data at the first computing device; creating first training data associated with the at least one pretext task, comprising processing the first portion of the first real-time medical video data; training the first machine learning model for the at least one pretext task based on the first training data associated with the at least one pretext task; obtaining a second portion of the first real-time medical video data; replacing, in a memory of the first computing device, the first portion of the real-time medical video data with the second portion of the real-time medical video data, wherein the memory is accessible only by the training program for training the first machine learning model; creating second training data associated with the at least one pretext task, comprising processing the second portion of the real-time medical video data; and training the first machine learning model based on the second training data associated with the at least one pretext task.

Optionally, the second machine learning model was trained for the at least one pretext task by: obtaining a first portion of the second real-time medical video data at the second computing device; creating first training data associated with the at least one pretext task, comprising processing the first portion of the second real-time medical video data; training the second machine learning model for the at least one pretext task based on the first training data associated with the second pretext task; obtaining a second portion of the second real-time medical video data; replacing, in a memory of the second computing device, the first portion of the second real-time medical video data with the second portion of the second real-time medical video data, wherein the memory is accessible only by the training program for training the second machine learning model; creating second training data associated with the at least one pretext task, comprising processing the second portion of the second real-time medical video data; and training the second machine learning model based on the second training data associated with the at least one pretext task.

Optionally, the first real-time medical video data is captured by a first endoscopic imaging system. Optionally, the second real-time medical video data is captured by a second endoscopic imaging system. Optionally, the first real-time medical video data comprises a video of a first surgical procedure. Optionally, the second real-time medical video data comprises a video of a second surgical procedure. Optionally, the first machine learning model comprises at least one of a transformer model and a convolutional neural network. Optionally, the second machine learning model comprises at least one of a transformer model and a convolutional neural network. Optionally, the first machine learning model is trained for the at least one pretext task using unsupervised learning. Optionally, the second machine learning model is trained for the at least one pretext task using unsupervised learning.

According to an aspect, a computing system for creating a foundation machine learning model using federated machine learning comprises one or more processors and a memory storing one or more programs that include instructions executable by the one or more processors for causing the computing system to: receive, at the computing system from a first computing device, model variables of a first machine learning model trained based on unlabeled image data obtained from first real-time medical video data for at least one pretext task, wherein the first real-time medical video data comprises video data captured during a first medical procedure; receive, at the computing system from a second computing device, model variables of a second machine learning model trained based on unlabeled image data obtained from second real-time medical video data for the at least one pretext task, wherein the second real-time medical video data comprises video data captured during a second medical procedure, wherein: a memory of the first computing device storing the unlabeled image data obtained from the first real-time medical video data is accessible only by a training program for training the first machine learning model and is accessible only during the first medical procedure, and a memory of the second computing device storing the unlabeled image data obtained from the second real-time medical video data is accessible only by a training program for training the second machine learning model and is accessible only during the second medical procedure; and aggregate the model variables of at least the first machine learning model and the second machine learning model to create the foundation machine learning model.

Optionally, the memory of the first computing device and the memory of the second computing device are a volatile memories. Optionally, the first computing device is located at a first medical facility, the second computing device is located at a second medical facility. Optionally, the first computing device is located in a first operating room of a medical facility and the second computing device is located in a second operating room of the medical facility.

According to an aspect, a non-transitory computer-readable storage medium stores instructions for creating a foundation machine learning model using federated machine learning, the instructions executable by a computing system comprising one or more processors to cause the computing system to: receive, at the computing system from a first computing device, model variables of a first machine learning model trained based on unlabeled image data obtained from first real-time medical video data for at least one pretext task, wherein the first real-time medical video data comprises video data captured during a first medical procedure; receive, at the computing system from a second computing device, model variables of a second machine learning model trained based on unlabeled image data obtained from second real-time medical video data for the at least one pretext task, wherein the second real-time medical video data comprises video data captured during a second medical procedure, wherein: a memory of the first computing device storing the unlabeled image data obtained from the first real-time medical video data is accessible only by a training program for training the first machine learning model and is accessible only during the first medical procedure, and a memory of the second computing device storing the unlabeled image data obtained from the second real-time medical video data is accessible only by a training program for training the second machine learning model and is accessible only during the second medical procedure; and aggregate the model variables of at least the first machine learning model and the second machine learning model to create the foundation machine learning model.

According to an aspect, a machine learning model is trained according to any of the methods disclosed herein.

It will be appreciated that any of the variations, aspects, features, and options described in view of the systems apply equally to the methods and vice versa. It will also be clear that any one or more of the above variations, aspects, features, and options can be combined.

### BRIEF DESCRIPTION OF THE FIGURES

The invention will now be described, by way of example only, with reference to the accompanying drawings, in which:

FIG. 1A shows an exemplary system for training machine learning models using real-time medical data according to some examples.

FIG. 1B shows an exemplary medical data processing device according to some examples.

FIG. 2 illustrates an exemplary medical data processing device according to some examples.

FIG. 3 illustrates an exemplary system for training a foundation machine learning model (i.e., foundation model) using federated learning according to some examples.

FIG. 4A shows an exemplary machine learning model for image reconstruction according to some examples.

FIG. 4B shows the exemplary machine learning model of FIG. 4A fine-tuned for image segmentation according to some examples.

FIG. 5 shows an exemplary machine learning model for image resolution enhancement according to some examples.

FIG. 6 shows an exemplary machine learning model for image quality enhancement according to some examples.

FIG. 7A shows an exemplary machine learning model for event sequencing/sequence ordering according to some examples.

FIG. 7B shows the exemplary machine learning model of FIG. 7A fine-tuned for action recognition according to some examples.

FIG. 8A shows an exemplary machine learning model for contrastive temporal distance according to some examples.

FIG. 8B shows the exemplary machine learning model of FIG. 8A fine-tuned for phase recognition according to some examples.

FIG. 9 shows an exemplary training process for different pretext tasks according to some examples.

FIG. 10 shows an exemplary method for training machine learning models using real-time medical data according to some examples.

FIG. 11 shows an exemplary method for federated training of machine learning models using real-time medical data according to some examples.

FIG. 12 shows an exemplary computing device according to some examples.

### DETAILED DESCRIPTION

It will be appreciated that any of the variations, aspects, features, and options described in view of the systems apply equally to the methods and vice versa. It will also be clear that any one or more of the above variations, aspects, features, and options can be combined.

Disclosed herein are systems, devices, and methods for training machine learning models using medical data and machine learning models trained according to the disclosed methods. The machine learning models disclosed herein are iteratively trained using real-time medical data of medical procedures. The medical data used to train the machine learning models disclosed herein is not stored in a database. In some aspects, portions of the real-time medical data are used to train a machine learning model in real time. The respective portions are continuously replaced (e.g., overwritten) in a memory of a computer used to train the machine learning model with more recent portions of the real-time medical data after the portion is used for training. Any remaining medical data (and/or training data derived therefrom) at the end of a medical procedure may be erased. Thus, the medical data may be inaccessible after the medical procedure ends. Accordingly, the systems, devices, and methods disclosed herein enable training of robust and accurate machine learning models while requiring significantly less data storage and management, providing enhanced privacy for patients, and mitigating concerns of healthcare professionals regarding recording surgical or other medical procedures.

An exemplary system may receive real-time medical data, such as medical video data and/or multimodal medical data of a surgical procedure. The system may train one or more machine learning models for one or more pretext tasks based on the real-time medical data. As used herein, a pretext task may refer to an unsupervised or self-supervised learning task such as image reconstruction, event sequencing (e.g., sequence ordering), contrastive learning, etc. In some examples, a plurality of machine learning models may be trained for one or more pretext tasks at a plurality of different sites (e.g., different hospitals or other medical facilities, different operating rooms). Model variables including parameters (e.g., weights) and/or gradients of the machine learning models from some or all of the respective sites may be aggregated into a foundation machine learning model using federated learning. Accordingly, a robust foundation machine learning model can be trained via federated learning without sharing the underlying video/image data from the medical procedure or the training data derived therefrom. Disclosed herein are privacy preserving training techniques that capture the technical benefits of federated learning, such as enhanced model accuracy derived from additional training data, without storing or sharing the underlying data.

In some examples, the machine learning models disclosed herein may subsequently be retrained or fine-tuned for downstream tasks such as image segmentation, action recognition, phase recognition, etc. The machine learning models may be trained for downstream tasks using labeled training data and supervised learning. The machine learning models may be used to process real-time medical data of medical procedures, enabling real-time image enhancement, object recognition, image segmentation, action recognition, phase recognition (e.g., surgical phase), etc. Outputs of the machine learning models disclosed herein may be displayed in real-time to users. Thus, the machine learning models disclosed herein can be used to augment clinical experience of physicians, providing doctors with enhanced visualizations during complex medical procedures, for example. The machine learning models disclosed herein may include any of a transformer architecture, a convolutional neural network (CNN) architecture, a long short-term memory (LSTM) architecture, a recurrent neural network (RNN) architecture, or other machine learning model architecture.

In the following description of the various examples, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

### System for Training Machine Learning Models

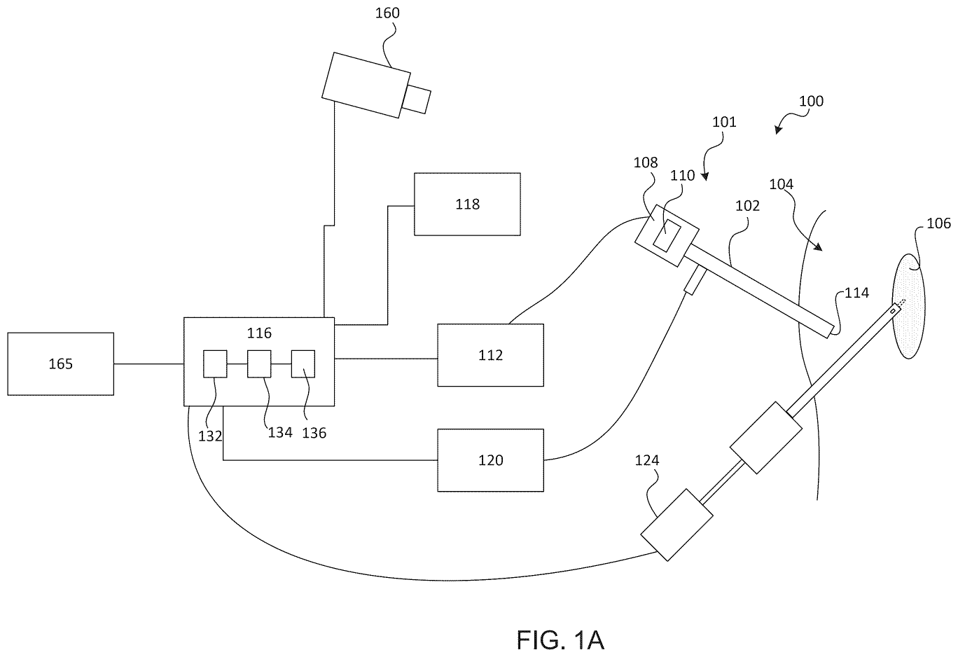

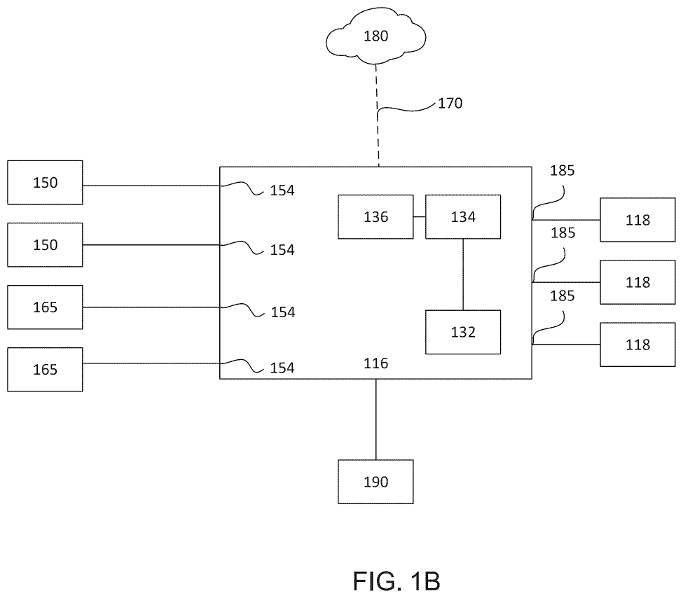

FIG. 1A illustrates an exemplary computing system 100 for training machine learning models based on real-time medical data, including real-time medical video data and/or multimodal medical data. The system 100 may include a medical data processing device 116 configured to process real-time medical video data obtained using an imaging device, such as imaging device 101 and/or imaging device 160. Real-time medical data may be acquired during a medical procedure using imaging device 101 and/or imaging device 160 and may be transmitted to the medical data processing device 116. The medical data processing device 116 may temporarily hold portions of the real-time medical data during the medical procedure in a memory 132 to create training data and train one or more machine learning models using one or more learning model training programs 134.

As different portions (e.g., frames, groups of frames) of video are received by medical data processing device 116, a portion currently held in memory is replaced (e.g., deleted) by a more recent portion. Memory 132 may be a volatile memory. Accordingly, when the real-time medical data ends (e.g., at the end of a medical procedure, when the medical data processing device 116 is powered off, when imaging device 101 and/or imaging device 160 are powered off, when a threshold amount of time has passed since the last portion of the real-time medical data was received), any portion of the real-time medical data held in the memory 132 may be erased. The memory 132 may only be accessible to the training program 134 for training the one or more machine learning models 136 and may be inaccessible after the medical procedure ends.

Imaging device 101 may be an endoscopic imager and may include a camera head 108 mounted to an endoscope 102. The endoscope 102 can be configured for insertion into a surgical cavity 104 for imaging tissue 106 within the surgical cavity 104 during a medical procedure. The endoscopic camera head 108 includes one or more imaging sensors 110. Light generated by a light source 120 may be directed through the endoscope 102 to the surgical cavity 104. Light reflected by and/or emitted from the tissue 106 (such as fluorescence light emitted from fluorescing targets that are excited by fluorescence excitation illumination light provided the light source 120) is received at the distal end 114 of the endoscope 102. The light is propagated by the endoscope 102, such as via one or more optical components (e.g., one or more lenses, prisms, light pipes, or other optical components), to the camera head 108, where it is directed onto the one or more imaging sensors 110. One or more filters (not shown) may be included in the endoscope 102, in a coupler (not shown) connecting the endoscope 102 to the camera head 108, and/or in the camera head 108 for filtering a portion of the light received from the tissue 106 (such as fluorescence excitation light).

The one or more imaging sensors 110 generate pixel data that can be transmitted to a camera control unit 112 that is communicatively connected to the camera head 108. The camera control unit 112 can generate real-time medical video data from the pixel data that shows the tissue 106 being viewed by the imaging device 101. One or more surgical tools 124 may be used in the surgical cavity 104 to manipulate tissue 106 during a surgical procedure on the patient, and the surgical tools may be captured in the images captured by the camera head 108 and included in the real-time medical video data. The real-time medical video data can be transmitted to medical data processing device 116 for further image processing and/or display.

The imaging device 160 may be a pan-tilt-zoom (PTZ) camera in an operating room, an open-field imaging device, an in-light camera (ILC), etc. Real-time video data obtained using imaging device 160 can be transmitted to medical data processing device 116 in addition to, or in place of, real-time medical video data obtained using imaging device 101.

The medical data processing device 116 receives the real-time medical video data from the camera control unit 112 and/or imaging device 160. The medical data processing device 116 may process the real-time medical video data, including creating training data using the real-time medical video data, training the one or more machine learning models using one or more learning model training programs 134, and/or applying one or more machine learning models 136 to the real-time medical video data, for instance, to enhance the video data. The one or more machine learning models 136 may include a transformer model architecture, a convolutional neural network (CNN), a long short-term memory (LSTM) architecture, other deep learning model, or any combination thereof. The medical data processing device 116 may train the one or more machine learning models 136 using the one or more machine learning model training programs 134 via unsupervised learning for a variety of pretext tasks (e.g., image enhancement, event sequencing, etc.). In some examples, the medical data processing device 116 may be used to train one or more machine learning models 136 for downstream tasks using labeled training data (e.g., image segmentation, action recognition, phase recognition, etc.) following unsupervised learning.

The processed real-time medical video data can be transmitted to the one or more displays 118, from the medical data processing device 116, for visualization by medical personnel, such as by a surgeon for visualizing the surgical cavity 104 during a surgical procedure on a patient. The camera control unit 112 and/or the medical data processing device 116 may be configured to send control signals to the light source 120 and/or the camera head 108 to control one or more aspects of the imaging, such as a timing sequence of light provided by the light source 120 (e.g., a sequence of white light and fluorescence excitation light), an amount of light provided by the light source 120, and/or a gain of the one or more imaging sensors 110.

FIG. 1B illustrates additional exemplary details of medical data processing device 116 of system 100. Medical data processing device 116 processes real-time medical data (e.g., real-time medical video data, multimodal medical data) received from one or more modalities such as imaging modalities 150 (which may include imaging modalities obtained using imaging device 101 and/or 160) to train one or more machine learning models 136 using one or more training programs 134 (and/or analyze using the machine learning model(s) 136). The real-time medical data may be temporarily held in a volatile memory 132 of medical data processing device 116 during a medical procedure for training and/or use of the machine learning model(s) 136. Outputs generated using the one or more machine learning models 136 may be shown on one or more displays 118. The one or more imaging modalities 150 may generate image data associated with treatment of a patient. The image data can include videos generated during treatment of the patient in support of one or more medical procedures, such as video captured by an endoscopic camera during an endoscopic procedure on a patient. Examples of medical imaging modalities include, without limitation, endoscopic systems, open field imaging systems, PTZ cameras, radiology systems, magnetic resonance imaging (MRI), etc.

In some examples, the medical data may include modalities such as text, electronic medical records, electronic health records, health information system records, patient chart data, medical history, audio (annotations, utterances during a procedure, speech-to-text data, etc.), radiology images, pre-operative images, settings or data from a connected device (telemetry, inertial measurement unit (IMU) data from a camera, motion sensor, robot including a robotic arm). Examples of the disclosure may include a multimodality approach, e.g., to train a machine learning model. In some aspects, the other modalities are used to train the model. For example, data from connected devices can be used to train the model to identify patterns of how the connected devices are used together and/or when the connected device are used (e.g., when the camera head is activated/deactivated for use, when the light source is activated/deactivated for use, etc.). In some aspects, data from a robot (including a robotic arm, such as motion data, image data, anatomical data, telemetry data, etc., from a robotic arm) or surgical tool may be used as training data. For example, telemetry data indicating pitch from the robotic arm may be tracked through a given procedure and used as training data for, e.g., a federated machine learning model (discussed in more detail below). The model can be used to identify anomalies in the surgical workflow and can be fine-tuned using labelled training data. In some aspects, the other modalities may be used with images to train the model. For example, the other modality may include text from utterances from the surgeon provided in real-time. The utterances may be converted into text using a speech-to-text algorithm. This text can be used in addition to the images captured during the procedure to train the model. The text may provide additional context to the image (e.g., type of anatomy in frame, surgical phase, etc.). The embeddings from the text may be combined with the embeddings from the images to train the model. In some aspects, the machine learning models can be fine-tuned using multimodal training data.

In some examples, the medical data processing device 116 may receive data from one or more non-imaging devices 165 that may be used in connection with (e.g., during) a medical imaging session and that may provide information that may be relevant for display and/or processing of the real-time medical video data during a medical imaging session. Non-limiting examples of non-imaging devices 165 include insufflators, illumination controllers, and voice control systems. Other non-limiting examples include defogging and smoke evacuation that could affect the state of the camera/OR.

The medical data processing device 116 may receive real-time medical video data from the one or more imaging modalities 150 through one or more input ports 154. The medical data processing device 116 generates one or more display feeds using received real-time medical video data and transmits the one or more display feeds to one or more displays 118 via one or more output ports 185. For example, the medical data processing device 116 may generate a display feed that includes an output of one or more machine learning models, such as enhanced imaging of tissue of a patient based on imaging generated by one or more imaging modalities 150, and the enhanced imaging may be displayed on one or more of the displays 118 to assist a user (e.g., a surgeon, a nurse, other medical personnel) during treatment of the patient. Input ports 154 and output ports 185 may be any suitable types of data transmission ports, such as DVI ports, HDMI ports, RS232 ports, IP ports, and the like.

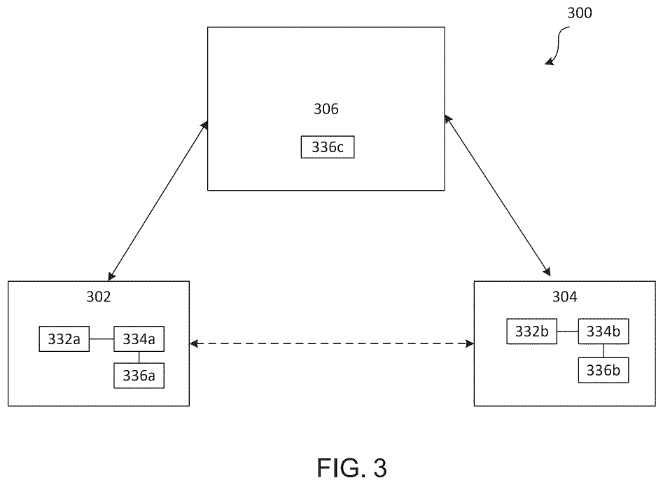

The medical data processing device 116 may be connected to one or more networks 180 via one or more network connections 170. The one or more networks 180 may be a local network such as a hospital information system or may be a wider network such as a wide area network or the internet. A network connection 170 can be a wired connection, such as an Ethernet connection, or a wireless network connection, such as a Wi-Fi connection. In some examples, the medical data processing device 116 may access the one or more networks 180 to retrieve configuration data stored at a network location for configuring the medical data processing device 116 for an imaging session, and/or may access the one or more networks to receive updated software and/or updated hardware files for processing imaging data. In some examples, system 100 may be used for federated training of a machine learning model. Network connections 170 be used to transmit and receive updated weights and/or gradients during federated learning, for instance, as described below with reference to FIG. 3. In some examples, the network connections 170 may be part of a medical telemetry.

One or more user interfaces 190 may be connected to the medical data processing device 116 for a user to provide input to the medical data processing device 116. The user may input data related to configuring the medical data processing device 116 for an imaging session. User input can include, for example, selection of a practitioner profile (e.g., a user profile as described herein) associated with an upcoming imaging session, selection of a type of imaging session or type of procedure to be performed during an imaging session, user selection of whether or not to implement the disclosed method (opt in or opt out of training or collecting data), user input to stop recording medical video data, or any other relevant information. The one or more user interfaces 190 may include a tablet, a keyboard, a mouse, a voice control system, a keypad, a touchscreen, or any combination thereof. The user interface 190 may have a wired or wireless connection. The input may be provided locally or remotely such as off-site from the medical facility (e.g., by an administrator or third party). As one non-limiting example, the input may be local data from a medical facility comprising a robot or robotic arm.

It should be appreciated that examples of the present disclosure can be used to load machine learning model(s) onto other types of target devices associated with a surgical environment or the system 100.

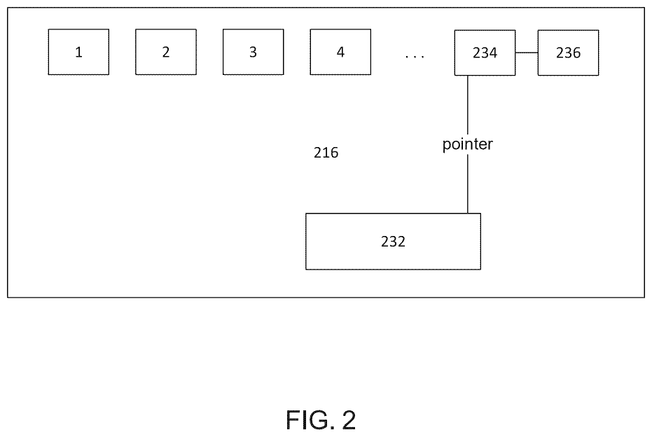

FIG. 2 illustrates an exemplary computing device 216 for training one or more machine learning models 236 using real-time medical data from a medical procedure, including real-time medical video data. Computing device 216 may be used for and include any of the aspects of medical data processing device 116 described above with reference to system 100. Computing device 216 includes a memory 232 configured to temporarily hold real-time medical data from a medical procedure (e.g., obtained using imaging device 101 and/or 160 described above). Memory 232 is a volatile memory (e.g., a random-access-memory (RAM), CPU, GPU, FGPA, etc.). Computing device 216 is configured to execute a plurality of computer programs. One or more machine learning model training programs 234 may be included in the plurality of computer programs. The machine learning model training programs 234 may be connected to memory 232 (e.g., may have access to memory 232 via a pointer). The machine learning model training programs 234 may thus have access to training data, including real-time medical data, temporarily held in memory 232. No other programs included in computing device 216 (e.g., programs 1, 2, 3, 4, etc.) have access to memory 232—only machine learning model training programs 234 have access to memory 232. Accordingly, the real-time medical data is only accessible by the one or more machine learning model training programs 234, for instance, to train one or more machine learning models 236 to enhance real-time medical data, etc.

### Federated Learning

FIG. 3 illustrates an exemplary system for federated training of a foundation machine learning model. System 300 includes a plurality of client computing devices, including computing device 302 and computing device 304, that are configured to train one or more machine learning models using real-time medical data. Computing device 302 and computing device 304 may each include any of the aspects of medical data processing device 116 and/or computing device 216 described above. Computing device 302 may include a memory 332a for temporarily holding portions of real-time medical data and one or more machine learning model training programs 334a for training a first machine learning model 336a. Computing device 304 may include a memory 332b for temporarily holding portions of real-time medical data and one or more machine learning model training programs 334b for training a second machine learning model 336b.

The client computing devices, including computing device 302 and computing device 304, may be connected to a remote computing system 306 (e.g., a remote server). Computing device 302 may be located at a different medical facility and/or in a different operating room from computing device 304. In some examples, model variables including parameters (e.g., weights) and/or gradients of the first machine learning model 336a and second machine learning model 336b may be transmitted to the computing system 306, and computing system 306 may aggregate the model variables including parameters (e.g., weights) and/or gradients (e.g., to create a combined foundation machine learning model). In some examples, the model variables including parameters (e.g., weights) and/or gradients of the first machine learning model 336a and second machine learning model 336b may be shared directly between the client computing devices, including computing device 302 and computing device 304, and the parameters may be aggregated at computing device 302 and/or computing device 304.

In some examples, computing device 302 may train first machine learning model 336a for a pretext task (e.g., image enhancement, event sequencing, etc.) based on first real-time medical data using machine learning model training program 334a. The first real-time medical data may be video of a first surgical procedure that may be received by computing device 302 and temporarily stored in memory 332a. Computing device 304 may train second machine learning model 336b for the pretext task (e.g., image enhancement, event sequencing, etc.) based on second real-time medical data using machine learning model training program 334b. The second real-time medical data may be video of a second surgical procedure that may be received by computing device 304 and temporarily stored in memory 332b. Computing device 302 may transmit a plurality of model variables including parameters (e.g., weights) and/or gradients associated with the first machine learning model 336a to computing system 306. Computing device 304 may transmit a plurality of the model variables including parameters (e.g., weights) and/or gradients associated with the second machine learning model 336b to computing system 306. The computing system 306 may aggregate the model variables including parameters (e.g., weights) and/or gradients associated with the first machine learning model 336a and second machine learning model 336b to create a foundation machine learning model 336c. Computing system 306 may transmit the aggregated model variables including parameters (e.g., weights) and/or gradients of the foundation machine learning model 336c back computing device 302 and/or computing device 304. The first machine learning model 336a at computing device 302 and the second machine learning model 336b at computing device 304 may be updated based on the aggregated parameters. Training of the first and second machine learning models and aggregation of the parameters from the first and second machine learning models may be iteratively repeated any number of times.

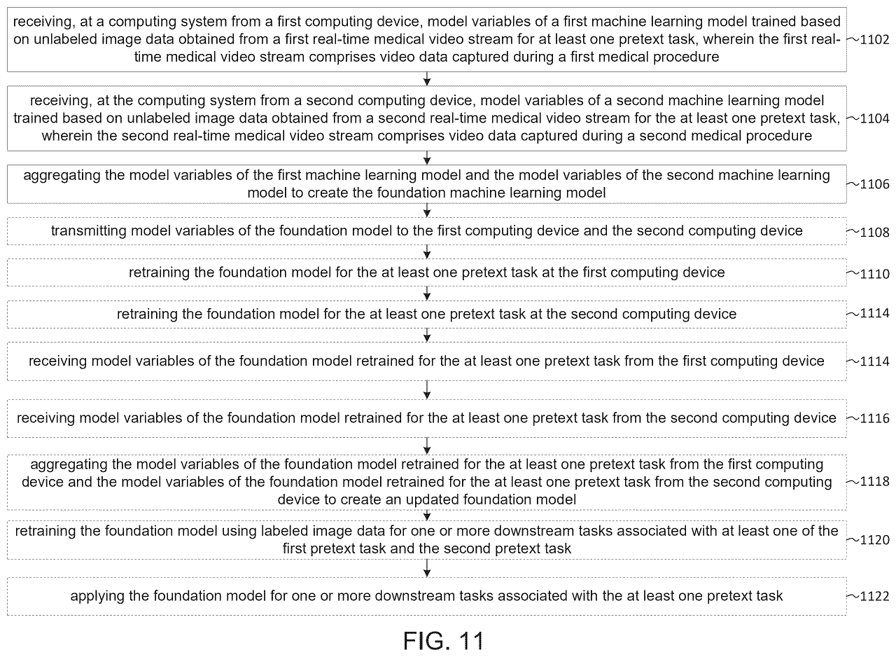

In some examples, computing device 302 and computing device 304 may transmit one or more model variables including parameters (e.g., weights) and/or gradients of the first and second machine learning models 336a and 336b directly to one another (e.g., via peer-to-peer data sharing). For example, computing device 302 may train the first machine learning model 336a for the pretext task (e.g., image enhancement, event sequencing, etc.) based on the first real-time medical data using training program 334a. Computing device 304 may train the second machine learning model 336b for the pretext task (e.g., image enhancement, event sequencing, etc.) based on second real-time medical data using training program 334b. Computing device 302 may transmit one or more model variables including parameters (e.g., weights) and/or gradients of the first machine learning model 336a to computing device 304. Computing device 304 may update the second machine learning model 336b based on the one or more model variables including parameters (e.g., weights) and/or gradients of the first machine learning model 336a. Similarly, computing device 304 may transmit one or more model variables including parameters (e.g., weights) and/or gradients of the second machine learning model 336b to computing device 302. Computing device 302 may update the first machine learning model 336a based on the one or more model variables including parameters (e.g., weights) and/or gradients of the second machine learning model 336b. Additional examples of federated learning are provided below with reference to FIG. 11.

### Pretext Task and Downstream Task Training Examples

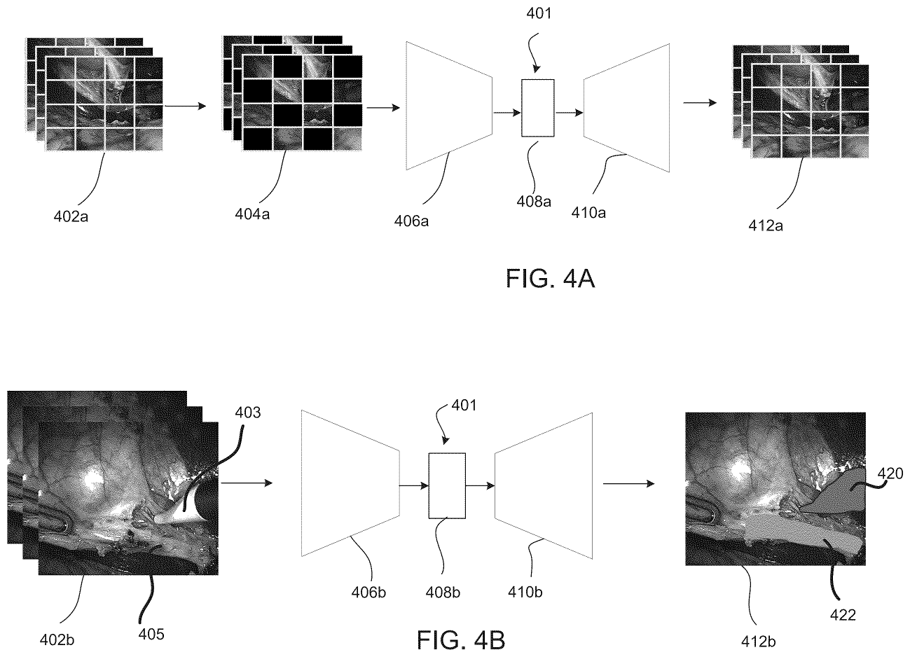

FIG. 4A shows an illustrative example of training a machine learning model 401 for an image reconstruction pretext task according to some examples of the disclosure. Machine learning model 401 may include a transformer, autoencoder, convolutional neural network, or other deep learning model. In some examples, the machine learning model 401 is trained via unsupervised or self-supervised learning to predict missing data in masked images. One or more input frames 402a may be acquired from real-time video data (e.g., of a medical procedure). The input frames 402a may be processed to create one or more masked frames 404a (e.g., frames of video data including one or more masked pixels). The one or more masked frames 404a may be input into an encoder 406a of a machine learning model 401. The encoder 406a may generate one or more lower-dimensional vector representations based on the one or more masked frames 404a in a latent space 408a. A decoder 410a may decode the one or more lower-dimensional vector representations to generate reconstructed frames 412a. The machine learning model 401 may be trained to minimize reconstruction error. In some examples, after training the machine learning model 401 to reconstruct masked image data (e.g., using unsupervised learning), it may be retrained for a downstream task using labeled image data, such as generating segmentation masks to overlay on input images. FIG. 4B shows an illustrative example of using machine learning model 401 for a downstream image segmentation task. One or more frames 402b (e.g., of a real-time video of a medical procedure) may be input into machine learning model 401. Encoder 406b of machine learning model 401 may encode the image data into lower-dimensional vector representations in latent space 408b. Decoder 410b may generate a pixel-wise mask based on the lower-dimensional vector representations. Overlays 420 and 422 may be generated and rendered on the image data to mask one or more target regions of the image (e.g., a surgical instrument 403 and/or anatomical feature 405) as shown in output 412b.

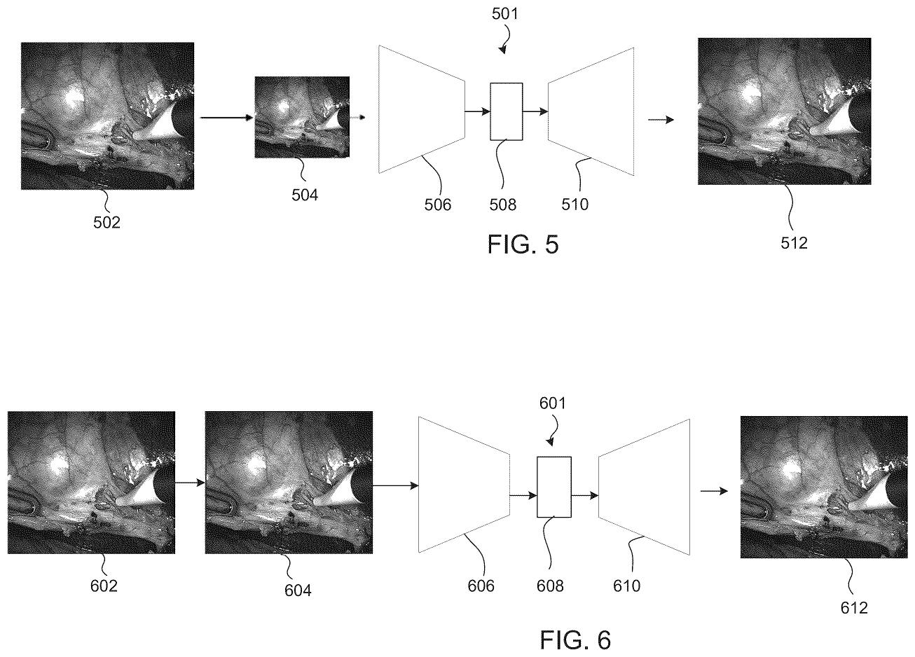

FIG. 5 shows an illustrative example of training a machine learning model 501 for another image reconstruction pretext task (image resolution enhancement) according to some examples of the disclosure. Machine learning model 501 may include a transformer, autoencoder, convolutional neural network, or other deep learning model. In some examples, the machine learning model 501 is trained via unsupervised or self-supervised learning to enhance resolution of input image/video data. During training, a high-resolution frame 502 may be received. The high-resolution frame 502 may be processed to generate a low-resolution image frame 504. Low-resolution image frame 504 may be input into machine learning model 501. The encoder 506 may generate one or more lower-dimensional vector representations based on the low-resolution image frame 504 in a latent space 508. Decoder 510 may decode the one or more lower-dimensional vector representations to generate a predicted reconstruction 512 of the high-resolution frame 502. The machine learning model 501 may be trained to minimize a reconstruction loss.

FIG. 6 shows an illustrative example of training a machine learning model 601 for another image reconstruction pretext task (image quality enhancement) according to some examples of the disclosure. Machine learning model 601 may include a transformer, autoencoder, convolutional neural network, or other deep learning model. In some examples, the machine learning model 601 is trained via unsupervised or self-supervised learning to enhance quality of input image/video data. During training, a high-quality frame 602 may be received. The high-quality frame 602 may be processed to generate a low-quality image frame 604. Low-quality image frame 604 may be input into machine learning model 601. The encoder 606 may encode a lower-dimensional vector representation of the low-quality image frame 604 in a latent space 608. Decoder 610 may decode a lower-dimensional vector representation of the low-quality image frame 604 to generate a predicted reconstruction 612 of the high-quality frame 602. The machine learning model 601 may be trained to minimize a reconstruction loss.

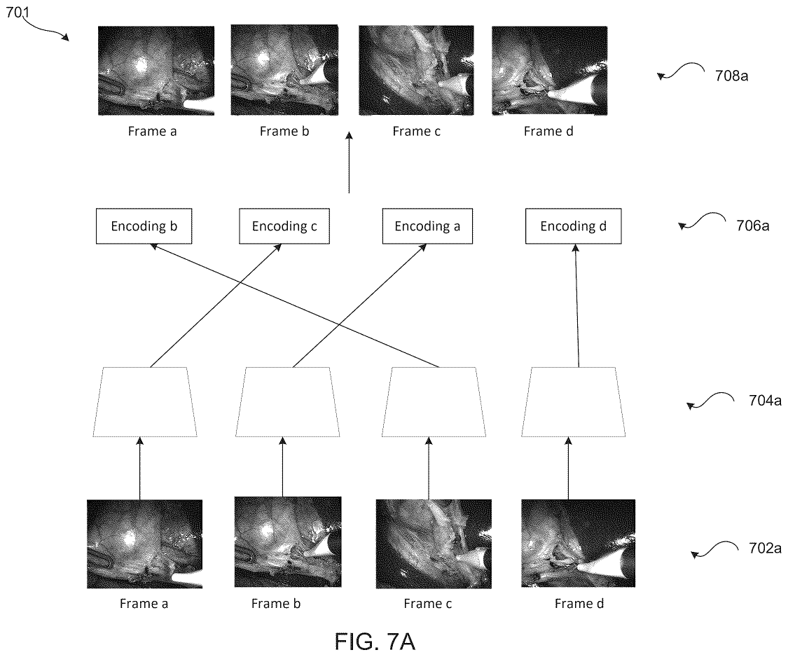

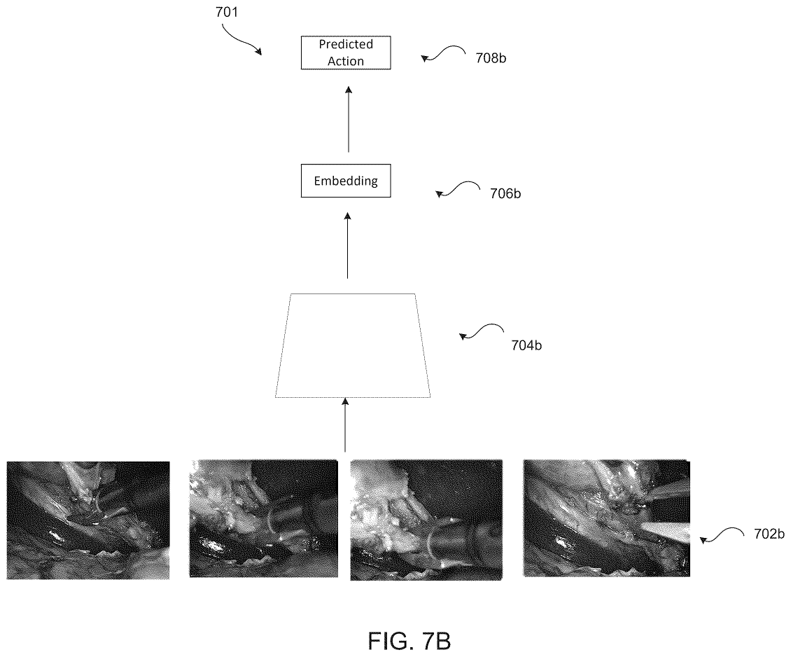

FIG. 7A shows an illustrative example of training a machine learning model 701 to predict an ordered sequence based on a temporally shuffled sequence of encodings. Machine learning model 701 may include a transformer, autoencoder, convolutional neural network, or other deep learning model. During training, an ordered sequence of frames 702a may be obtained (e.g., from real-time video data of a medical procedure). The ordered sequence of frames 702a may be input into a machine learning model 701. An encoder layer 704a of the machine learning model 701 may encode the ordered sequence of frames 702a into a plurality of temporally shuffled encodings in a latent space 706a. An output layer 708a (e.g., a task-specific head) may be trained to predict an ordered sequence based on the shuffled sequence of encodings. In some examples, after training the machine learning model 701 to predict ordered sequences (e.g., using unsupervised learning), it may be retrained for a downstream task using labeled image data, such as classifying actions based on image/video data. FIG. 7B shows an illustrative example of using machine learning model 701 for a downstream action recognition task. An ordered sequence of frames 702b may be obtained (e.g., from real-time video data of a medical procedure), and the ordered sequence of frames 702b may be input into a machine learning model 701. An encoder layer 704b of the machine learning model 701 may encode the ordered sequence of frames 702b into at least one encoding 706b. The output layer 708b may predict an action class (e.g., grasp, cut, clip, etc.) based on at least one encoding.

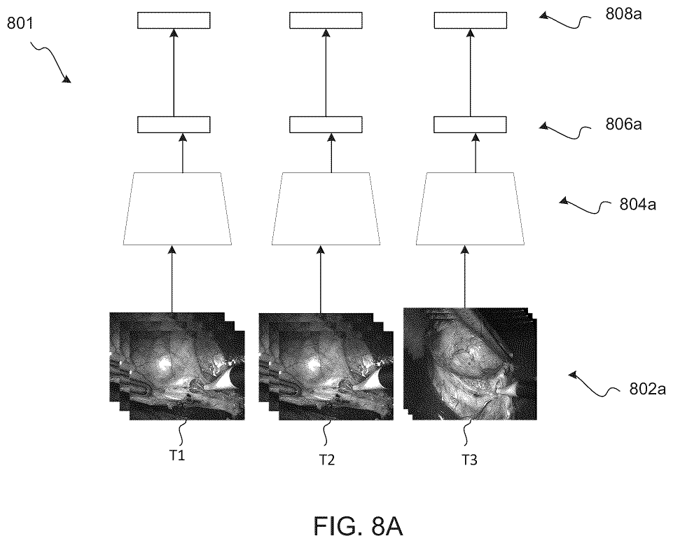

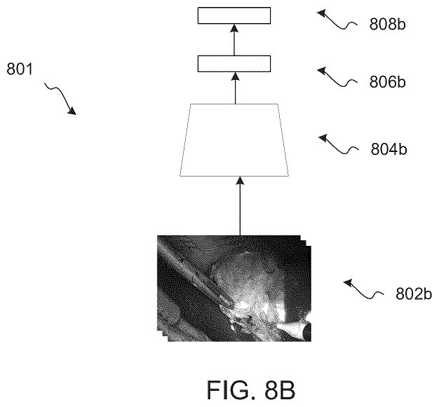

FIG. 8A shows an illustrative example of training a machine learning model 801 to identify temporally close and temporally distant portions of time-series medical video data via contrastive temporal distance learning. At block 802a, frames from three different times (T1, T2, and T3) are obtained from a time series of video data. Times T1 and T2 are temporally adjacent to one another (e.g., T1 may be the first five (5) seconds of a video, and T2 may be the next five (5) seconds of the video). Times T2 and T3 are temporally distant from one another (e.g., T2 may be the five (5) seconds of video following T1, and T3 may be fifty (50) through fifty-four (54) seconds of the same video such that nearly a full minute passes between T2 and T3). At block 804a, the frames obtained at each of times T1, T2, and T3 are input into an encoder. The encoder obtains lower-dimensional representations 806a (e.g., encodings) of the frames obtained at each of times T1, T2, and T3. At block 808a, machine learning model 801 is trained to identify temporally close and temporally distant portions of time-series medical video data based on the lower-dimensional representations 806a. FIG. 8B shows an illustrative example of using machine learning model 801 for a downstream action recognition task. One or more frames (e.g., from real-time medical video data) are obtained at block 802b. At block 804b, a lower-dimensional representation of the one or more frames is obtained using an encoder. At block 806b, machine learning model 801 analyzes the lower-dimensional representation of the one or more frames to predict a phase 808b associated with the one or more frames.

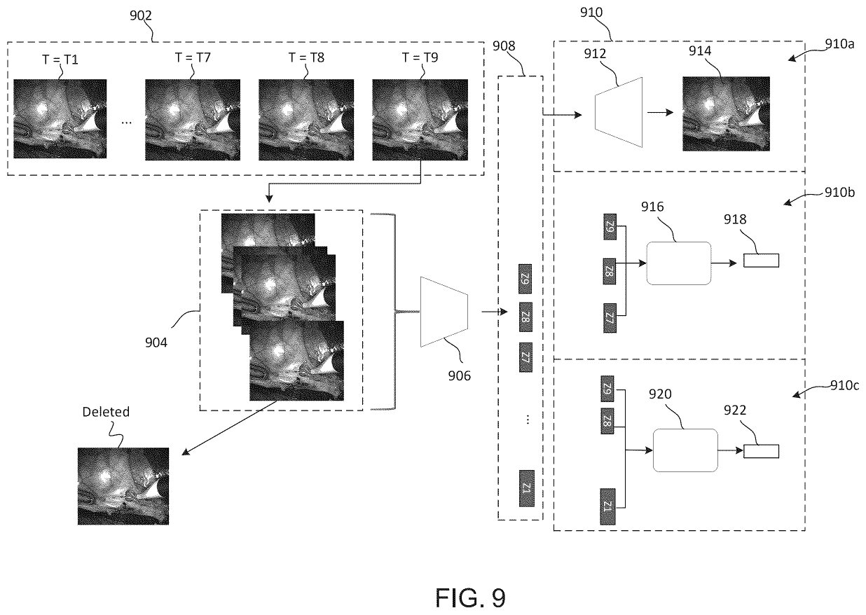

FIG. 9 shows an exemplary training sequence for pretext task training according to one or more examples described herein. Frames from real-time medical video data 902 (e.g., a frame at time T1 . . . time T7, time T8, time T9) are received by a frame buffer 904. After receipt into the frame buffer 904, the frames of the real-time medical video data may be processed (e.g., modified) to create training data. For instance, full-resolution frames may be received into frame buffer 904. The full-resolution frames may then be processed to create low-resolution frames to be included in the training data. It should be understood, however, that the frames may be pre-processed prior to receipt into the frame buffer 904 to format the frames as training data for a respective pretext task.

The frame buffer 904 may be a volatile memory. Frame buffer 904 may be, or form a part of, memory 132 of medical data processing device 116, memory 232 of computing device 216, memory 332a of computing device 302, and/or memory 332b of computing device 304. The frame buffer 904 may only be accessible by a training program or programs for training one or more machine learning models 910 (e.g., training program 134, 234, 334a, 334b). The frame buffer 904 may also have a maximum capacity and may operate on a first-in-first-out basis. A maximum number of frames may be received into the frame buffer 904. When any frames beyond the maximum capacity of the frame buffer 904 are received, one or more frames of the original maximum number of frames may be replaced by the additional frames received. Accordingly, only the machine learning model training program (e.g., training program 134, 234, 334a, 334b) can access the video data in the frame buffer 904, and the video data in the frame buffer is iteratively replaced as new data is received. None of the video data is permanently stored. Moreover, as described throughout, the video data may be inaccessible after the end of the medical procedure. Thus, the video data is obtained, held temporarily to train a machine learning model in real time (e.g., as described with reference to the remaining aspects of FIG. 9), and then erased.

An encoder 906 may receive each frame received into the frame buffer 904 and may encode each frame into a lower-dimensional encoding. The encodings (e.g., Z1 . . . Z7, Z8, Z9) corresponding to each frame may be received into an encoding buffer 908 (although, it should be understood that a group of frames, including all frames in the buffer, could be encoded into a single embedding). The encoding buffer 908 may be configured to hold a maximum number of encodings. The maximum number of encodings in encoding buffer 908 may correspond to the maximum number of frames received into the frame buffer 904. The maximum number of encodings in encoding buffer may be different than the maximum number of frames received into the frame buffer.

The one or more machine learning models 910 (e.g., a model including a plurality of task-specific heads or multiple machine learning models) may be trained for a plurality of pretext tasks using the encodings in encoding buffer 908. A first pretext task 910a may be an image reconstruction machine learning model. One or more encodings may be input into a decoder 912 to reconstruct a high-resolution (or high-quality, etc.) image frame 914 based on one or more encodings of lower resolution (or lower quality) image data.

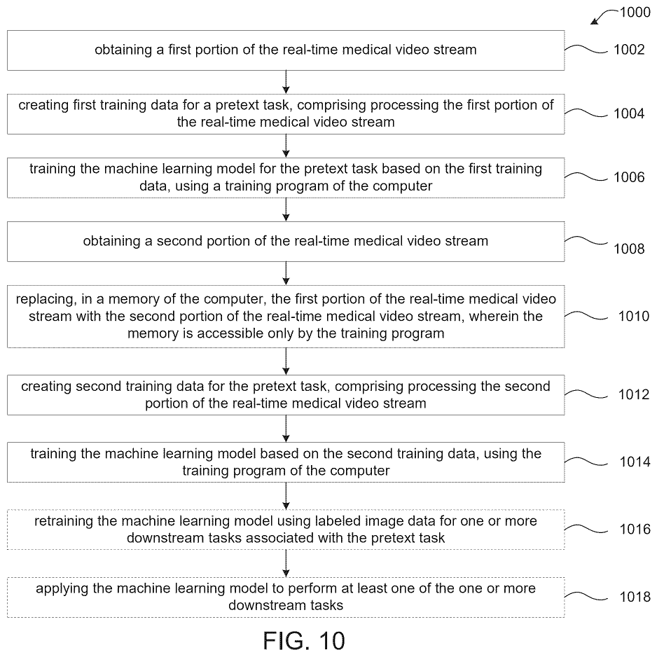

A second pretext task 910b may be an event sequencing pretext task. A sequence of encodings (Z7, Z8, and Z9) may be shuffled, and a task-specific head 916 may be trained to reconstruct an ordered sequence 918 based on the shuffled sequence of encodings. A third pretext task 910c may be a contrastive temporal distance task. A first set of encodings, Z8 and Z1, may be temporally distant from one another. A second set of encodings, Z8 and Z9, may be temporally adjacent to one another. A task-specific head 920 may be trained to predict temporally similar and temporally different portions as output 922 of time-series data based on the two sets of encodings. Additional exemplary details of pretext tasks the models described herein may be trained for are provided below with reference to FIGS. 10 and 11.

### Training Method

FIG. 10 illustrates an exemplary method 1000 for training a machine learning model based on real-time medical data, including real-time medical video data, from a medical procedure. Method 1000 may be implemented using one or more aspects of system 100 and/or computing device 216. At block 1002, an exemplary system (e.g., system 100) obtains a first portion of real-time medical video data. The real-time medical video data may include video data of a medical procedure, such as a surgical procedure. The first portion of the real-time medical video data may include one or more frames of the real-time medical video data and/or a video segment of the real-time medical video data. The first portion of real-time medical video data may be received from an imaging device of system 100, such as imaging device 101 (e.g., endoscope 102) or imaging device 160 (e.g., a PTZ camera). The real-time medical video data may include any real-time multi-spectral medical video feed captured using an endoscopic imaging device, a fluoroscopic imaging device, an open field camera, a PTZ camera, or other imaging device used to capture video and/or image data during a medical procedure.

At block 1004, the system creates first training data for a pretext task (e.g., using medical data processing device 116 or computing device 216). Creating the first training data for the pretext task may include processing the first portion of the real-time medical video data. Processing the first portion of the real-time medical video data may include generating first modified data, which may include introducing noise into one or more frames from the first portion of the real-time medical video data, or otherwise modifying the one or more frames from the first portion of the real-time medical video data, such as by applying image masks (e.g., binary masks), rearranging a sequence of frames, rotating frames, cropping frames, blurring frames, etc. The noise introduced into the frames from the first portion of the real-time medical video data may include Gaussian noise, random noise, etc. The first modified data may be included in the first training data.

In some aspects, masked image data may be created to train the machine learning model to reconstruct frames of video data (by filling in masked portions) captured during a medical procedure to ensure medical operators (e.g., surgeons, medical staff, and the like) have an unobstructed view of target anatomy. That is, the model is trained to reconstruct image data such that any missing pixels/obstructions are “filled in” so that medical staff are presented with unobstructed images. For example, first training data may be created by masking one or more pixels of image data (e.g., as shown in FIG. 4A). Masking the one or more pixels may include applying an image mask to one or more frames of the first portion of the real-time medical video data. The image mask may include a binary image mask. The image mask may be a pixel-wise mask. Applying the image mask may include assigning a binary value (e.g., 1 or 0) to each pixel of a respective frame, the binary value indicating whether the pixel is hidden or visible. The image mask may be applied algorithmically (e.g., using medical data processing device 116 or computing device 216). The frames that include one or more masked pixels may be included in the first training data.

In some aspects, the machine learning models disclosed herein may be employed to enhance video data for use by healthcare professionals during medical procedures, for instance, providing healthcare professionals with improved visualizations of anatomical features, leading to more efficient and safer surgical procedures and better patient outcomes. For instance, some medical imaging devices may produce lower-resolution images/video. Training data including low-resolution image data can be created to train a machine learning model to enhance image resolution. Accordingly, creating the first training data may include creating one or more low-resolution frames, for instance, by reducing an image resolution of one or more frames of the first portion of the real-time medical video data. The one or more low-resolution frames may be included in the first training data. The machine learning model(s) may be trained to enhance low-resolution images, for instance, as shown in the illustrative example depicted in FIG. 5.

In some examples, creating the first training data includes creating one or more low-quality frames. Creating one or more low-quality frames may include reducing an image quality of one or more frames of the first portion of the real-time medical video data (e.g., by increasing compression, adding noise, adding blur, etc.). The first training data may include one or more low-quality frames. Low-quality frames may be created to train the machine learning models to enhance low-quality images received from medical imaging devices that may produce lower-quality image data. An illustrative example of a machine learning model being trained to enhance image quality is shown in FIG. 6 and discussed above.

In some aspects, a temporally modified sequence of frames (or encodings) may be created to train the machine learning model to understand temporal relationships in video data, for instance, as described above with reference to the example depicted in FIG. 7A. Such training may be valuable for downstream tasks like action recognition or other classification tasks (e.g., as illustrated in FIG. 7B). In some examples, creating the first training data, including processing the first portion of the real-time medical video data, includes creating a temporally modified sequence of frames. Creating the temporally modified sequence of frames may include rearranging a sequence of a plurality of frames of the first portion of the real-time medical video data. The first training data may include the temporally modified sequence of frames. In some examples, creating the temporally modified sequence of frames includes encoding a lower-dimensional representation (e.g., encodings) of a plurality of frames in a sequence of frames, for instance, using an encoder of the machine learning model. Each encoding may encode temporal information associated with a respective frame while reducing the overall data processing burden on the system by omitting unimportant information included in the original video data. The encodings may be rearranged in a latent space such that they are temporally shuffled relative to the original order.

In some examples, creating the first training data includes creating at least one set of temporally adjacent frames and at least one set of temporally distant frames for instance, as illustrated in FIG. 8A. Training data including at least one set of temporally adjacent frames and at least one set of temporally distant frames may be used for contrastive temporal distance learning tasks, which may enable the machine learning models disclosed herein to learn temporal relationships between portions of time-series data. Machine learning models with such understanding of temporal relationships between portions of time-series data may be valuable for tasks such as surgical phase recognition (e.g., as shown in FIG. 8B). Temporally adjacent frames may be frames that are within a threshold temporal distance from one another (e.g., temporally adjacent frames may be separated by less than 1 second, less than 5 seconds, less than 10 seconds, etc.). In some examples, temporally distant frames are more than a threshold distance away from one another (e.g., more than 50 seconds apart, more than 100 seconds apart, etc.). Creating at least one set of temporally adjacent frames may include identifying at least two temporally adjacent frames of a plurality of frames of the first portion of the real-time medical video data, which may form the at least one set of temporally adjacent frames. Creating the at least one set of temporally distant frames may include identifying at least two temporally distant frames of the plurality of frames of the first portion of the real-time medical video data, which may form the at least one set of temporally distant frames. The first training data may include the at least one set of temporally adjacent frames and the at least one set of temporally distant frames.

At block 1006, the exemplary system trains the machine learning model for the pretext task based on the first training data, using a training program of the computer (e.g., a machine learning model training program of medical data processing device 116 or computing device 216). Training the machine learning model for the pretext task based on the first training data may include inputting the first modified data (which may be generated by introducing noise into, reducing image quality of, reducing image resolution of, rearranging, etc., one or more frames from the first portion of the real-time medical video data) into the machine learning model. Training the machine learning model for a pretext task may include training the machine learning model using self-supervised or unsupervised training. The first training data may include unlabeled training data. The first training data may include modified frames from real-time medical video data configured for one or more particular pretext tasks. The pretext task(s) may include, for instance, an image reconstruction task, an event sequencing task, a contrastive temporal distance task, or any other pretext task. The machine learning model may be trained for a single pretext task or multiple pretext tasks. In some examples, the machine learning model includes multiple task-specific heads each trained for a respective pretext task. Pretext task training using unlabeled training data obtained from real-time medical data enables construction of a foundation machine learning model that can be fine-tuned for downstream tasks such as image segmentation and object detection (e.g., detection of organs, detection of lesions, detection of surgical instruments, etc.), among other downstream tasks.

Examples of the disclosure that include training the machine learning model for image reconstruction using masked image data (e.g., as shown in FIG. 4A) enable the machine learning model to learn to encode and reconstruct meaningful features such as structural and spatial characteristics of the image data (e.g., edges, shapes, textures). These learned representations enable the machine learning model to quickly adapt to identify other information, such as semantic boundaries, which may be valuable for downstream tasks like object recognition and segmentation mask generation (e.g., as shown in FIG. 4B). In some examples, the pretext task includes an image reconstruction pretext task. For instance, the machine learning model may be trained to reconstruct masked, blurred, cropped, low-quality, low-resolution, missing, etc., image data (e.g., pixels) based on unlabeled training data obtained from real-time medical video data. Training the machine learning model for the image reconstruction pretext task based on the first training data may include training the machine learning model to reconstruct image data that includes one or more masked pixels. The first portion of the real-time medical video data may be obtained and processed as described above to create training data that includes image frames with masked pixels, for instance, as described at block 1004. Any type of image mask may be applied to the frames to create the first training data. The one or more frames that include one or more masked pixels may be input into the machine learning model, and the machine learning model may be trained to generate reconstructed images while minimizing a reconstruction loss.

In some examples, training the machine learning model for an image reconstruction pretext task includes training the machine learning model to reconstruct a high-resolution frame from low-resolution image data (e.g., as shown in FIG. 5). Training the machine learning model for an image reconstruction task using low-resolution frames enables the machine learning model to learn a mapping function between low-resolution image data and high-resolution image data such that the machine learning model can be used to generate high-resolution frames that can be displayed to a user (e.g., a surgeon, medical staff, and the like) during a medical procedure, enabling efficient treatment and improved patient outcomes. The system may create one or more low-resolution frames by reducing an image resolution of one or more frames of the first portion of the real-time medical video data. The low-resolution images may be input into the machine learning model, and the machine learning model may be trained to predict/reconstruct a higher-resolution frame (or frames, video segment, etc.) based on a low-resolution frame (or frames, video segment, etc.) while minimizing a loss function.

In some examples, training the machine learning model for an image reconstruction pretext task includes training the machine learning model to reconstruct a high-quality frame from low-quality image data (e.g., as shown in FIG. 6). The system may generate one or more low-quality frames by reducing an image quality of one or more frames of the first portion of the real-time medical video data. The low-quality frames may be input into the machine learning model, and the machine learning model may be trained to predict/reconstruct a higher-quality frame (or frames, video segment, etc.) based on a low-quality frame (or frames, video segment, etc.) while minimizing a loss function. Similar to use of the low-resolution training data, training the machine learning model for an image reconstruction task using low-quality frames enables the machine learning model to learn a mapping function between low-quality image data and high-quality image data such that the machine learning model can be used to generate high-quality frames that can be displayed to a medical operator (e.g., a physician) during a medical procedure, enabling efficient treatment and improved patient outcomes.

In some examples, the pretext task includes an event sequencing pretext task (e.g., as shown in FIG. 7A). The system may receive a sequence of frames from the real-time medical video data and create a temporally modified sequence of frames based on the received sequence to use for training the machine learning model. The system may create the temporally modified sequence of frames by rearranging a sequence of a plurality of frames of the first portion of the real-time medical video data. The temporally modified sequence of frames may be included in the first training data. Training the machine learning model to predict/reconstruct an ordered sequence of frames may include inputting the temporally modified sequence of frames into the machine learning model. The system may train the machine learning model to predict/reconstruct an ordered sequence of frames (e.g., temporally ordered such that earlier frames are earlier-occurring in the ordered sequence than later-occurring frames) based on the temporally modified sequence of frames. Training the machine learning model to predict/reconstruct an ordered sequence of frames may include minimizing a loss function measuring a difference between the true order of the sequence of frames and a predicted order of the sequence generated based on the shuffled sequence. In some examples, as discussed above with reference to creating training data at block 1004, creating the temporally modified sequence of frames includes encoding a lower-dimensional representation (e.g., encodings) of a plurality of frames in a sequence of frames, for instance, using an encoder of the machine learning model. The encodings may be rearranged in a latent space such that they are temporally shuffled relative to the original order. The system may train the machine learning model to predict/reconstruct an ordered sequence of frames (e.g., temporally ordered) based on the temporally shuffled sequence of encodings. Training the machine learning model to predict/reconstruct an ordered sequence of frames may include minimizing a loss function, measuring a difference between the true order of the sequence of frames and a predicted order of the sequence generated based on the shuffled sequence of encodings.

Training the machine learning model for an event sequencing pretext task may be valuable for downstream tasks such as action recognition and phase recognition (e.g., as shown in FIG. 7B and FIG. 8B). Unsupervised learning for event sequencing trains the foundation machine learning model to capture temporal dependencies and patterns in input data. Training the foundation model to recognize sequences of events may enable the foundation model to better recognize particular actions associated with those events. The machine learning model may then be readily adapted to action recognition and/or phase recognition tasks via supervised learning.

In some examples, the pretext task includes a contrastive learning task. In some examples, the contrastive learning task includes a contrastive temporal distance pretext task (e.g., as shown in FIG. 8A). The system may create at least one set of temporally adjacent frames and at least one set of temporally distant frames to use for training the machine learning model. Creating at least one set of temporally adjacent frames may include identifying at least two temporally adjacent frames of a plurality of frames of the first portion of the real-time medical video data. Creating at least one set of temporally distant frames (e.g., relatively more distant from one another than the temporally adjacent frames) may include identifying at least two temporally distant frames of the plurality of frames of the first portion of the real-time medical video data. The first training data may include the at least one set of temporally adjacent frames and the at least one set of temporally distant frames. Training the machine learning model may include inputting the at least one set of temporally adjacent frames and the at least one set of temporally distant frames into the machine learning model. The system may train the machine learning model to identify temporal relationships in time-series image data. Similar to an event sequencing pretext task, training the machine learning model for a contrastive temporal distance task enables the machine learning model to learn to differentiate between sequences of events or states over time, which may enable the machine learning model to capture temporal dynamics and contrast different temporal sequences. If later fine-tuned for phase classification, the foundation model may leverage its pretext training to distinguish between different phases using temporal features identified by the foundation model based on the input data.

At block 1008, the system obtains a second portion of the real-time medical video data. The second portion of the real-time medical video data may include one or more frames of the real-time medical video data and/or a video segment of the real-time medical video data. The second portion may include image and/or video data that is more recent than the first portion of the real-time medical video data. For instance, the system may continuously or periodically receive portions of the real-time medical video data. The first portion received at block 1002 may be received at a first time, and the second portion may be received at a second time after the first time.

At block 1010, the system replaces, in a memory (e.g., memory 132, memory 232, frame buffer 904) of the computer (e.g., medical data processing device 116 or computing device 216), at least a subset of the first portion of the real-time medical video data with the second portion of the real-time medical video data. The second portion of real-time medical video data may be obtained using an imaging device of system 100, such as imaging device 101 (e.g., endoscope 102) or imaging device 160. In some aspects, the first portion, or subset thereof, that is replaced may be erased from the memory of the computer. Accordingly, as different portions of video are received, the portion temporarily held in memory is iteratively replaced (e.g., deleted). When the real-time video data ends (e.g., at the end of a medical procedure, when the device is powered off, when a threshold amount of time has passed since the last portion of the real-time medical video data was received), any portion of the real-time medical video data held in the memory may be erased. Moreover, the memory may be accessible only by the training program for training the one or more machine learning models, such as machine learning model training program 134 or machine learning model training program 234 described above. In some examples, no other programs have access to a pointer to the memory where the portions of the real-time medical video data are temporarily held during the medical procedure for training the machine learning model. For instance, as shown in FIG. 2, only machine learning model training program 234 has access to a pointer to memory 232. No other programs (e.g., applications), including programs 1, 2, 3, 4, etc., as shown, can access memory 232. The training program (e.g., training program 234, 134) with access to the memory (e.g., 232, 132) can thus access the training data stored in the memory to train the machine learning model (e.g., machine learning model 136), while the training data (including the real-time medical video data) remains isolated from all other programs. The real-time medical video data is used to train the machine learning model in real-time, and then the video is no longer accessible. Therefore, the training process described herein requires no creation of a database of training data and mitigates privacy concerns inherent in conventional training methods using sensitive medical data.

As an example of the replacement of the first portion of the real-time medical video data by the second portion of the real-time medical video data, the first portion may be a single frame or may include a plurality of frames. The second portion may be a single frame or may include a plurality of frames (e.g., obtained using imaging device 101 or imaging device 160). In some examples, a plurality of frames may be received by the memory (e.g., into memory 132, memory 232, frame buffer 904) until a capacity of the memory or other threshold is reached. Once the threshold is reached, at least a subset (optionally, including all) of the first portion may be replaced by a second portion of the real-time medical video data. For example, the second portion may include the next frame received after the threshold is reached. The first frame of the first portion received by the memory may be replaced by the first frame of the second portion (e.g., similar to a first-in-first-out process).

At block 1012, the system creates second training data for the pretext task. Creating the second training data may include processing the second portion of the real-time medical video data. The second training data may be created by processing the second portion of the real-time medical video data while it is held in the memory (e.g., memory 132, memory 232, frame buffer 904). The second training data may be created by processing the second portion of the real-time medical video data in the same manner as the first portion of the real-time medical video data. For instance, the first portion of the real-time medical video data may be processed to create masked image frames for an image reconstruction pretext task. The second training data, which is created based on a subsequent portion of the real-time medical video data, may be processed in the same manner to create the same type of training data for the same pretext task. Thus, the machine learning model may be iteratively trained using training data that is created using each subsequent portion of the real-time medical video data.

Processing the second portion of the real-time medical video data may include generating second modified data. Generating the second modified data may include introducing noise into the one or more frames from the second portion of the real-time medical video data, or otherwise modifying the one or more frames from the second portion of the real-time medical video data such as by applying image masks (e.g., binary masks), rearranging a sequence of frames, rotation, cropping, blurring, etc. The noise introduced into the one or more frames from the second portion of the real-time medical video data may include Gaussian noise, random noise, etc. The second modified data may be included in the second training data.

In some examples, creating the second training data includes creating one or more frames that include one or more masked pixels. Creating one or more frames that include one or more masked pixels may include applying an image mask to one or more frames of the second portion of the real-time medical video data (e.g., as shown in FIG. 4A). The image mask may include a binary image mask. Applying the image mask may include assigning a binary value (e.g., 1 or 0) to each pixel of a respective frame, the binary value indicating whether the pixel is hidden or visible. The image mask may be applied algorithmically (e.g., using medical data processing device 116 or computing device 216). The one or more frames that include the one or more masked pixels may be included in the second training data.

In some examples, creating the second training data includes creating one or more low-resolution frames (e.g., as shown in FIG. 5). Creating the one or more low-resolution frames may include reducing an image resolution of one or more frames of the second portion of the real-time medical video data. The one or more low-resolution frames may be included in the second training data. In some examples, creating the second training data includes creating one or more low-quality frames (e.g., as shown in FIG. 6). Creating the one or more low-quality frames may include reducing an image quality of one or more frames of the second portion of the real-time medical video data. The second training data may include the one or more low-quality frames.

In some examples, creating the second training data includes creating a temporally modified sequence of frames (e.g., as shown in FIG. 7A). Creating the temporally modified sequence of frames may include rearranging a sequence of a plurality of frames of the second portion of the real-time medical video data. The second training data may include the temporally modified sequence of frames. In some examples, creating the second training data includes creating at least one set of temporally adjacent frames and at least one set of temporally distant frames (e.g., as shown in FIG. 8A). Creating the at least one set of temporally adjacent frames may include identifying at least two temporally adjacent frames of a plurality of frames of the second portion of the real-time medical video data, which may form at least one set of temporally adjacent frames. Creating at least one set of temporally distant frames may include identifying at least two temporally distant frames of the plurality of frames of the second portion of the real-time medical video data, which may form the at least one set of temporally distant frames. The second training data may include the at least one set of temporally adjacent frames and the at least one set of temporally distant frames.

At block 1014, the system (e.g., system 100) trains the machine learning model (e.g., machine learning model 136) based on the second training data. Training the machine learning model for the pretext task based on the second training data may include inputting the second modified data (which may be generated by introducing noise to, reducing resolution of, reducing quality of, rearranging, etc., one or more frames from the second portion of the real-time medical video data) into the machine learning model. Training the machine learning model for a pretext task may include training the machine learning model using self-supervised or unsupervised training. The second training data may include unlabeled training data, which may include modified frames from the real-time medical video data configured for the same pretext task(s) that the machine learning model was trained for at block 1006. The pretext task(s) may include, for instance, an image reconstruction task, an event sequencing task, a contrastive temporal distance task, or any other pretext task. The machine learning model may be trained for a single pretext task or multiple pretext tasks. In some examples, the machine learning model includes multiple heads each trained for a respective pretext task.

As described with reference to block 1006 above, in some examples, the pretext task includes an image reconstruction pretext task. The system may create one or more frames that include one or more masked pixels. Creating one or more frames that include one or more masked pixels may include applying an image mask to one or more frames of the second portion of the real-time medical video data. Training the machine learning model for the image reconstruction pretext task based on the second training data may include training the machine learning model to reconstruct image data that include one or more masked pixels. The second portion of the real-time medical video data may be obtained and processed as described above (e.g., with reference to block 1006 and the first training data) to create training data that include image frames with masked pixels. Any type of image mask may be applied to the frames to create the second training data. The training data that include one or more masked pixels may be input into the machine learning model, and the machine learning model may be trained to reconstruct unmasked image frames while minimizing a reconstruction loss.

In some examples, training the machine learning model for an image reconstruction pretext task includes training the machine learning model to reconstruct a high-resolution frame based on low-resolution image data. The system may create one or more low-resolution frames by reducing an image resolution of one or more frames of the second portion of the real-time medical video data to use for training the machine learning model. The low-resolution images may be included in the second training data. Training the machine learning model to reconstruct high-resolution image data based on low-resolution image data may include inputting the one or more low-resolution frames into the machine learning model. The machine learning model may be trained to predict/reconstruct a higher-resolution frame (or frames, video segment, etc.) based on a low-resolution frame (or frames, video segment, etc.) while minimizing a reconstruction loss.

In some examples, training the machine learning model for an image reconstruction pretext task includes training the machine learning model to reconstruct a high-quality frame based on low-quality image data. The system may generate one or more low-quality frames by reducing an image quality of one or more frames of the second portion of the real-time medical video data to use for training the machine learning model. The low-quality frames may be included in the second training data and used to train the machine learning model. Training the machine learning model to reconstruct high-quality image data based on low-quality image data may include inputting the one or more low-quality frames into the machine learning model. The machine learning model may be trained to predict/reconstruct a higher-quality frame (or frames, video segment, etc.) based on a low-quality frame (or frames, video segment, etc.) while minimizing a reconstruction loss.

In some examples, the pretext task includes an event sequencing pretext task. The system may receive a sequence of frames from the real-time medical video data and create a temporally modified sequence of frames based on the received sequence to use for training the machine learning model. The system may create the temporally modified sequence of frames by rearranging a sequence of a plurality of frames of the second portion of the real-time medical video data. The temporally modified sequence of frames may be included in the second training data. Training the machine learning model to predict/reconstruct an ordered sequence of frames may include inputting the temporally modified sequence of frames into the machine learning model. The system may train the machine learning model to predict/reconstruct an ordered sequence of frames based on the temporally modified sequence of frames while minimizing a loss function (e.g., a mean square error loss function).

In some examples, creating the temporally modified sequence of frames includes generating a plurality of encodings respectively associated with a plurality of frames in a sequence of frames. Each encoding may encode temporal information associated with a respective frame. The encodings may be rearranged in a latent space such that they are temporally shuffled relative to the original order. The system may train the machine learning model to predict/reconstruct an ordered sequence of frames (e.g., temporally ordered) based on the temporally shuffled sequence of encodings. Training the machine learning model to predict/reconstruct an ordered sequence of frames may include minimizing a loss function measuring a difference between the true order of the sequence of frames and a predicted order of the sequence generated based on the shuffled sequence of encodings.

In some examples, the pretext task includes a contrastive learning task. In some examples, the contrastive learning task includes a contrastive temporal distance pretext task. The system may create at least one set of temporally adjacent frames and at least one set of temporally distant frames to use for training the machine learning model. Creating at least one set of temporally adjacent frames may include identifying at least two temporally adjacent frames of a plurality of frames of the second portion of the real-time medical video data. Creating at least one set of temporally distant frames may include identifying at least two temporally distant frames of the plurality of frames of the second portion of the real-time medical video data. The second training data may include the at least one set of temporally adjacent frames and the at least one set of temporally distant frames. Training the machine learning model may include inputting the at least one set of temporally adjacent frames and the at least one set of temporally distant frames into the machine learning model. The system may train the machine learning model to identify temporal relationships in time-series image data.

As noted above, while blocks 1002-1014 are described above with reference to a first and a second portion, it should be understood that first and second may refer to any two portions of real-time medical video data. Moreover, it should be understood that any number of portions of the real-time medical video data may be obtained and used to iteratively train the machine learning model for a pretext task. Further, while method 1000 is described specifically with reference to medical video data, aspects of the disclosure include method 1000 as applied to multimodal medical data such as text, electronic medical records, electronic records, etc.

In some examples, the machine learning model trained for the pretext task may be used for one or more downstream tasks. In some examples, the downstream task may be the same as the pretext task. For instance, the downstream task may include enhancing an image quality or an image resolution. In some examples where the machine learning model was trained for an image reconstruction pretext task including reconstructing an image quality, the trained machine learning model may be used to generate relatively higher quality frames of real-time video data during a medical procedure. The real-time medical video data (e.g., of a surgical procedure) may include one or more relatively low-quality frames. The real-time medical video data including the one or more low-quality frames may be input into the trained machine learning model and the trained machine learning model may generate high-quality frames (e.g., higher quality relative to the input). For instance, the trained machine learning model may encode a low-quality frame into a lower-dimensional vector representation using an encoder and may generate a high-quality frame based on the lower-dimensional vector representation using a decoder. The generated high-quality frames can then be displayed to a user (e.g., a physician) during the medical procedure, enabling efficient treatment, improved patient outcomes, etc.

In some examples where the machine learning model was trained for an image reconstruction pretext task including reconstructing an image resolution, the trained machine learning model may be used to enhance the image resolution of real-time video data during a medical procedure. The real-time medical video data (e.g., of a surgical procedure) may include one or more low-resolution frames. The real-time medical video data including the one or more low-resolution frames may be input into the trained machine learning model and the trained machine learning model may generate high-resolution frames (e.g., higher resolution relative to the input). For instance, the trained machine learning model may encode a low-resolution frame into a lower-dimensional vector representation using an encoder and may generate a high-resolution frame based on the lower-dimensional vector representation using a decoder. The generated high-resolution frames can then be displayed to a user (e.g., a physician) during the medical procedure, enabling efficient treatment, improved patient outcomes, etc.

At block 1016, the method optionally includes retraining the machine learning model using labeled image data for one or more downstream tasks associated with the pretext task. In some examples, the machine learning model trained for one or more pretext tasks may be retrained (e.g., fine-tuned) using labeled training data for a downstream task such as object recognition, action recognition, etc., associated with one or more pretext tasks. The machine learning model trained for the pretext task may be retrained based on the labeled input data according to any training process (e.g., backpropagation, gradient descent). The machine learning model may be retrained/fine-tuned at the same computer or at a different computer than was used to train the machine learning model for the pretext ask, at a different computing system than was used to train the machine learning model for the pretext ask, on the cloud, etc. In some examples, the labeled image data for the one or more downstream tasks associated with the pretext task comprises labeled surgical image data obtained during a surgical procedure.

In some examples, the one or more downstream tasks include a semantic segmentation downstream task. Retraining/fine-tuning the machine learning model for semantic segmentation may include inputting labeled image and/or video data into the machine learning model trained for the image reconstruction pretext task. The labeled image and/or video data may include labels assigned to one or more pixels. The machine learning model may be trained to detect one or more objects in image data input into the machine learning model, generate a segmentation mask based on the labeled image and/or video data, etc. In examples where the machine learning model is trained for object detection, it may be trained to recognize anatomical features (e.g., organs, soft tissue, hard tissue, etc.), surgical tools (e.g., surgical drill, shaver, burr, and the like), and/or other objects in image data of a surgical procedure. The machine learning model may be trained to generate labels that can be overlayed on the input video/image data labeling the anatomical features.

In some examples, the semantic segmentation downstream task is associated with an image reconstruction pretext task (e.g., a machine learning model trained for image reconstruction may later be fine-tuned for semantic segmentation). In examples where the machine learning model is trained for an image reconstruction pretext task, it may be suited for fine-tuning for semantic segmentation because unsupervised learning for image reconstruction enables the machine learning model to learn to encode and reconstruct meaningful features such as structural and spatial characteristics of the image data (e.g., edges, shapes, textures). These learned representations enable the model to quickly adapt to identifying semantic boundaries in input image/video data. However, it should be understood that a model trained for any or all of the pretext tasks described above may be retrained/fine-tuned for semantic segmentation.

Following training, the trained machine learning model may be used for image segmentation on real-time medical video data. Real-time medical video data including the one or more low-resolution frames may be input into the machine learning model trained for semantic segmentation and the trained machine learning model may generate segmentation masks. For instance, the trained machine learning model may encode a frame of video data into a lower-dimensional representation (e.g., a vector representation that may be referred to as an encoding, capturing important features included in the input data) using an encoder. The trained machine learning model may decode the encoding back to its original dimensionality, producing a pixel-wise prediction map, assigning labels to the pixels in the image. The machine learning model may identify objects in the input frame, generate overlays (e.g., masks) that are displayed over the original input frame, etc., that may be displayed to a user (e.g., a physician) to enable more efficient and effective treatment during a medical procedure.

In some examples, the one or more downstream tasks includes an action recognition downstream task. The action recognition downstream task may include classifying an action detected based on image data of a surgical procedure. The action may include a surgical action, such as, cutting, grasping, clipping, etc. In some examples, the action recognition downstream task is associated with an event sequencing pretext task (e.g., in some examples when the machine learning models disclosed herein are trained for an event sequencing pretext task, they may be fine-tuned for action recognition). However, it should be understood that a model trained for any or all of the pretext tasks described above may be retrained/fine-tuned for action classification. For instance, the action classification task could be associated with the contrastive temporal distance pretext task.

In some examples where the machine learning model is trained for an event sequencing pretext task, it may be suited for fine-tuning for an action recognition downstream task because unsupervised learning for event sequencing trains the machine learning model to capture temporal dependencies and patterns in input data. Training the model to recognize sequences of events may enable the model to better recognize particular actions associated with those events. Retraining/fine-tuning the machine learning model for action classification may include inputting labeled image and/or video data into the machine learning model trained for the event sequencing pretext task.

In some examples, the one or more downstream tasks includes a phase recognition downstream task. The phase recognition task may include classifying a phase of a medical procedure (e.g., a phase of a surgical procedure) based on image data of a surgical procedure. Surgical phases may include, for instance, “Preparation,” “Dissection,” “Clipping and Cutting,” and “Extraction,” each of which may be associated with a particular procedure, such as Laparoscopic Cholecystectomy. In some examples, the phase recognition downstream task is associated with a contrastive temporal distance pretext task (e.g., in some examples when the machine learning models disclosed herein are trained for a contrastive temporal distance pretext task, they may be fine-tuned for phase recognition). However, it should be understood that a model trained for any or all of the pretext tasks described above may be retrained/fine-tuned for action classification. For instance, the phase classification task could be associated with the event sequencing pretext task.

In examples where the machine learning model is trained for a contrastive temporal distance pretext task, it may be suited for fine-tuning for a phase recognition downstream task because unsupervised learning for a contrastive temporal distance pretext task trains the machine learning model to differentiate between sequences of events or states over time, which may enable the machine learning model to capture temporal dynamics and contrast different temporal sequences. When fine-tuned for phase classification, the model may leverage its pretext training to distinguish between different phased based on temporal features identified by the machine learning model based on the input data. Retraining/fine-tuning the machine learning model for phase classification may include inputting labeled image and/or video data that includes labels (e.g., semantic labels of phases) assigned to the input image and/or video data into the machine learning model trained for the contrastive temporal distance pretext task.

At block 1018, the method optionally includes applying the machine learning model to perform at least one of the one or more downstream tasks. Applying the machine learning model to perform a downstream task may include enhancing a resolution and/or quality of real-time video data, generating a segmentation mask based on real-time video data, classifying an action based on real-time video data, classifying a phase based on real-time video data, etc.

Method 1000 is performed, for example, using one or more electronic devices implementing a software platform. In some examples, method 1000 is performed using one or more electronic devices. Method 1000 may be performed using one or more aspects of system 100, for instance, including medical data processing device 116. In some examples, method 1000 is performed using a client-server system, and the blocks of method 1000 are divided up in any manner between the server and one or more client devices. In some examples, method 1000 is performed using a peer-to-peer system, and the blocks of method 1000 are divided up in any manner between one or more devices. Thus, while portions of method 1000 are described herein as being performed by particular devices, it will be appreciated that method 1000 is not so limited. In method 1000, some blocks are, optionally, combined, the order of some blocks is, optionally, changed, and some blocks are, optionally, omitted. In some examples, additional steps may be performed in combination with the method 1000. Accordingly, the operations as illustrated (and described in greater detail above) are exemplary by nature and, as such, should not be viewed as limiting.

Method 1000 is described above with reference to a first and second portion of real-time medical video data. A “portion” of the real-time medical video data may include any amount of data from the video data, and the system may continuously receive portions of the real-time medical video data, overwrite the previous portion in a memory of the system (e.g., memory 132 of system 100), and iteratively train a machine learning model (e.g., machine learning model 136 of system 100) using more recent portions of video data (e.g., video data captured following the preceding portion) received into the memory. In some examples, demographic information (e.g., age, sex, ethnicity) associated with the real-time medical video may be obtained by the system. The demographic information may be used by the system to counteract bias in the machine learning models disclosed herein. In some examples, the demographic information may be stored in a database for record keeping. Although the method 1000 of FIG. 10 is described with reference to using real-time medical video data to train the model in real time (e.g., during a surgical procedure), in some examples, a lower-dimensional vector representation of the video data (e.g., an encoding or an embedding) or other medical data such as multimodal medical data may be saved and later used to train the machine learning model. The encodings/embeddings may be encrypted, may not include patient identifying information, and/or may not be used to recreate the original video or other medical data.

In some examples, any of the machine learning models disclosed herein may be trained using federated machine learning. In such examples, a plurality of machine learning models may be trained for one or more pretext tasks at respective local sites (e.g., hospitals, etc.). Each of the plurality of machine learning models may be trained according to the method 1000. A foundation machine learning model may be created by aggregating the machine learning models (and/or model variables including parameters (e.g., weights) and/or gradients thereof) trained at the local sites. For instance, each machine learning model at a respective local site may be trained for the same pretext task or tasks. The model variables including parameters (e.g., weights) and/or gradients of each of those models can then be aggregated to create a foundation model that has the benefit of training data obtained at each of the local sites. Federated learning according to the methods described herein enables the training of a robust foundation model based on additional training data from each respective local site without requiring that any of the video data used to train the respective models be stored in a database.

### Federated Learning Method

FIG. 11 illustrates an exemplary method 1100 for creating a foundation machine learning model using federated machine learning. At block 1102, an exemplary computing system (e.g., computing system 306 of FIG. 3) receives, from a first computing device (e.g., computing device 302 of FIG. 3), a first machine learning model (e.g., machine learning model 336a) trained based on unlabeled image data obtained from a first real-time medical data for at least one pretext task. The first real-time medical data may include medical data captured during a first medical procedure. The first real-time medical data may have been captured by a first imaging system (e.g., endoscopic imaging system, etc.) and may include video of a first surgical procedure. In some examples, only model variables including parameters (e.g., weights) and/or gradients of the first machine learning model are received at the computing system for aggregation into the foundation machine learning model. At block 1104, the computing system receives, from a second computing device (e.g., computing device 304 of FIG. 3), a second machine learning model (e.g., machine learning model 336b) trained based on unlabeled image data obtained from a second real-time medical data for the at least one pretext task. The second real-time medical data may include video data captured during a second medical procedure. The second real-time medical data may have been captured by a second imaging system (e.g., endoscopic, etc.) and may include video of a second surgical procedure. In some examples, only model variables including parameters (e.g., weights) and/or gradients of the second machine learning model are received at the computing system for aggregation into the foundation machine learning model.

The unlabeled image data obtained from the first real-time medical data and the second real-time medical data may not be transmitted to the computing system at which the machine learning models are aggregated (e.g., computing system 306). In some aspects, the first real-time medical data and the second real-time medical data may be continuously processed and deleted from a memory of the first and second computing device (e.g., memory 332a of device 302 and memory 332b of device 304), respectively, as the first and second machine learning models are trained during a medical procedure. The machine learning models can therefore be trained at local sites associated with the first and second computing devices without permanently storing the video data or training data derived from the video data and without permitting access to the video data or training data derived from the video data to any other computing devices. In some examples, no patient identifying information associated with the first real-time medical data or the second real-time medical data is sent to the computing system at which the machine learning models are aggregated.

In some examples, a memory of the first computing device (e.g., memory 332a) storing the unlabeled image data obtained from the first real-time medical data is accessible only by a training program (e.g., training program 334a) for training the first machine learning model and is accessible only during the first medical procedure. In some examples, a memory of the second computing device (e.g., memory 332b) storing the unlabeled image data obtained from the second real-time medical data is accessible only by a training program (e.g., training program 334b) for training the second machine learning model and is accessible only during the second medical procedure. The memory of the first computing device (e.g., memory 332a) and/or the memory of the second device (e.g., memory 332b) may be a volatile memory.

The at least one pretext task may include any of those described with reference to the method 1000 of FIG. 10. The at least one pretext task may include an image reconstruction pretext task. The image reconstruction task may include reconstruction of high-quality image data from low-quality image data, reconstruction of high-resolution image data from low-resolution image data, and/or reconstruction of unmasked image data from masked image data. The at least one pretext task may include an event sequencing pretext task, which may include reconstruction of an ordered sequence of image data. The at least one pretext task may include a contrastive temporal distance pretext task. The contrastive temporal distance pretext task may include identification of one or more temporally adjacent portions of image data in a time series of image data and one or more temporally distant portions of image data in a time series of image data. In some examples, the at least one pretext task includes only one pretext task. In some examples, the at least one pretext task includes a plurality of pretext tasks.

In some examples, the first machine learning model is trained for the at least one pretext task by creating first training data based on a first real-time medical data and training the first machine learning model based on the first training data. The first computing device may obtain a first portion of the first real-time medical data at the first computing device. The first computing device may create first training data associated with the at least one pretext task based on the first portion of the first real-time medical data. Creating the first training data may include processing the first portion of the first real-time medical data. The first computing device may process the first portion of the first real-time medical data to create the first training data in any manner described above with reference to the method 1000 of FIG. 10. The first computing device may train the first machine learning model for the at least one pretext task based on the first training data associated with the at least one pretext task. The first computing device may train the first machine learning model for the at least one pretext task according to any of the pretext task training procedures described above with reference to the method 1000 of FIG. 10.

In some examples, the first computing device obtains a second portion of the first real-time medical data and replaces, in a memory of the first computing device, the first portion of the real-time medical data with the second portion of the real-time medical data. The memory may be accessible only by the training program for training the first machine learning model. The first computing device may create second training data associated with the at least one pretext task. Creating the second training data may include processing the second portion of the real-time medical data. The first computing device may process the second portion of the real-time medical data in the same manner as the first computing device processed the first portion to create the second training data. The first computing device may train the first machine learning model for the at least one pretext task based on the second training data associated with the at least one pretext task. The first computing device may iteratively obtain portions of the first real-time medical data, create training data, and train the first machine learning model for any number of iterations. The first machine learning model may include at least one of a transformer model and a convolutional neural network. The first machine learning model may be trained for the at least one pretext task using unsupervised learning.

In some examples, the second machine learning model is trained for the at least one pretext task by creating first training data based on a second real-time medical data and training the second machine learning model based on the first training data. The second machine learning model may be trained at a different computing device than the first machine learning model and may be trained using a different video of a different surgical procedure than the first machine learning model. The second computing device may obtain a first portion of the second real-time medical data at the second computing device. The second computing device may create first training data associated with the at least one pretext task based on the first portion of the second real-time medical data. Creating the first training data may include processing the first portion of the second real-time medical data. The second computing device may process the first portion of the second real-time medical data to create the first training data in any manner described above with reference to the method 1000 of FIG. 10. The second computing device may train the second machine learning model for the at least one pretext task based on the first training data associated with the at least one pretext task obtained from the first portion of the second real-time medical data. The second computing device may train the second machine learning model for the at least one pretext task according to any of the pretext task training procedures described above with reference to the method 1000 of FIG. 10.

In some examples, the second computing device obtains a second portion of the second real-time medical data and replaces, in a memory of the second computing device, the first portion of the second real-time medical data with the second portion of the second real-time medical data. The memory may be accessible only by the training program for training the second machine learning model. The second computing device may create second training data associated with the at least one pretext task, which may include processing the second portion of the second real-time medical data. The second computing device may process the second portion of the second real-time medical data in the same manner as the second computing device processed the first portion of the second real-time medical data to create the second training data. The second computing device may train the second machine learning model for the at least one pretext task based on the second training data associated with the at least one pretext task. The second computing device may iteratively obtain portions of the second real-time medical data, create training data, and train the second machine learning model for any number of iterations. The second machine learning model may include at least one of a transformer model and a convolutional neural network. The second machine learning model may be trained for the at least one pretext task using unsupervised learning.

At block 1106, the computing system aggregates the first machine learning model and the second machine learning model to create the foundation machine learning model. The system may aggregate a plurality of model variables including parameters (e.g., weights) and/or gradients of at least the first machine learning model and the second machine learning model to create the foundation machine learning model. The computing system may aggregate trainable parameters such as weights and/or gradients to create the foundation model according to known methods. The localized training (e.g., at different local sites/computing devices) and remote aggregation (e.g., at a centralized server, on the cloud, etc.) described above may be iteratively repeated any number of times, for instance, as set forth below in blocks 1108 through 1118.

At block 1108, the computing system optionally transmits a copy of the foundation model to the first computing device and the second computing device. At block 1110, the foundation model is optionally retrained for the at least one pretext task at the first computing device. At block 1112, the foundation model is optionally retrained for the at least one pretext task at the second computing device. The foundation model may be retrained at the first and second computing device according to any of the steps described herein with reference to training the machine learning models for a pretext task or pretext tasks. For instance, the first and/or second computing device may obtain portions of real-time medical data, create training data, and train a respective copy of the foundation model using the training data. The first and second computing devices may then transmit their retrained copy of the foundation model back to the computing system. At block 1114, the computing system optionally receives the foundation model that was retrained for the at least one pretext task at the first computing device from the first computing device. At block 1116, the computing system optionally receives the foundation model that was retrained for the at least one pretext task at the second computing device from the second computing device.

At block 1118, the computing system optionally aggregates the foundation model retrained for the at least one pretext task from the first computing device and the foundation model retrained for the at least one pretext task from the second computing device to create an updated foundation model. The above disclosed pretext task training and model aggregation steps may be iteratively performed any number of times to construct a robust foundation model. The foundation model may then be applied and/or retrained (e.g., fine-tuned) to carry out a variety of downstream tasks, such as image enhancement, image segmentation, action classification, etc., exemplary details of which are described below with reference to blocks 1120 and 1122.

At block 1120, the foundation model is optionally retrained (e.g., fine-tuned) using labeled image data for one or more downstream tasks associated with the at least one pretext task. The foundation model may be retrained based on the labeled input data according to any training process (e.g., backpropagation, gradient descent). The downstream tasks may include any of those described above with reference to the method 1000 of FIG. 10, for instance, the downstream task may include image reconstruction and/or enhancement, semantic segmentation, object recognition, action recognition, phase recognition, etc. The foundation model may be retrained/fine-tuned at the same computer or at a different computer than was used to train the foundation model for the pretext task, a different computing system than was used to train the foundation model for the pretext task, on the cloud, etc. In some examples, the labeled image data for the one or more downstream tasks associated with the pretext task comprises labeled surgical image data obtained during a surgical procedure.

In some examples, the one or more downstream tasks include a semantic segmentation downstream task. The semantic segmentation downstream task may include detecting one or more objects in image data input into the foundation model. The objects may be anatomical features (e.g., organs, organs, soft tissue, hard tissue, etc.), surgical tools (e.g., surgical drill, shaver, burr, and the like), and/or other objects in image data of a surgical procedure. In some examples, the semantic segmentation downstream task is associated with an image reconstruction pretext task. In examples where the foundation model is trained for an image reconstruction pretext task, it may be suited for fine-tuning for semantic segmentation because unsupervised learning for image reconstruction enables the foundation model to learn to encode and reconstruct meaningful features such as structural and spatial characteristics of the image data (e.g., edges, shapes, textures). These learned representations enable the foundation model to quickly adapt to identifying semantic boundaries in input image/video data. Retraining/fine-tuning the foundation model for semantic segmentation may include inputting labeled image and/or video data into the foundation model trained for the image reconstruction pretext task. The foundation model may be trained to predict a pixel-wise segmentation mask based on the labeled image and/or video data. The foundation model may be trained to minimize a loss function measuring the difference between predicted labels for each pixel and ground truth labels. While described with reference to an image reconstruction pretext task, it should be understood that a foundation model trained for any or all of the pretext tasks described above may be retrained/fine-tuned for semantic segmentation.

In some examples, the one or more downstream tasks includes an action recognition downstream task. The action recognition downstream task may include classifying an action detected based on image data of a surgical procedure. The action may include a surgical action, such as cutting, grasping, clipping, etc. In some examples, the action recognition downstream task is associated with an event sequencing pretext task. In examples where the foundation model is trained for an event sequencing pretext task, it may be suited for fine-tuning for an action recognition downstream task because unsupervised learning for event sequencing trains the foundation model to capture temporal dependencies and patterns in input data. Training the foundation model to recognize sequences of events may enable the foundation model to better recognize particular actions associated with those events. Retraining/fine-tuning the foundation model for action classification may include inputting labeled (e.g., including semantic labels of actions) image and/or video data that includes labels into the foundation model trained for the event sequencing pretext task. The foundation model may be trained to minimize a loss function measuring the difference between the predicted actions and ground truth labels. While described with reference to an event sequencing pretext task, it should be understood that a foundation model trained for any or all of the pretext tasks described above may be retrained/fine-tuned for action recognition.

In some examples, the one or more downstream tasks includes a phase recognition downstream task. The phase recognition task may include classifying a phase of a medical procedure (e.g., a phase of a surgical procedure) based on image data of a surgical procedure. Surgical phases may include, for instance, “Preparation,” “Dissection,” “Clipping and Cutting,” and “Extraction,” each of which may be associated with a particular procedure, such as Laparoscopic Cholecystectomy. In some examples, the phase recognition downstream task is associated with a contrastive temporal distance pretext task. In examples where the foundation model is trained for a contrastive temporal distance pretext task, it may be suited for fine-tuning for a phase recognition downstream task because unsupervised learning for a contrastive temporal distance pretext task trains the foundation model to differentiate between sequences of events or states over time, which may enable the machine learning model to capture temporal dynamics and contrast different temporal sequences. When fine-tuned for phase classification, the foundation model may leverage its pretext training to distinguish between different phased based on temporal features identified by the foundation model based on the input data. Retraining/fine-tuning the foundation model for phase classification may include inputting labeled image and/or video data (e.g., including semantic labels of phases) into the foundation model trained for the contrastive temporal distance pretext task. The foundation model may be trained to minimize a loss function measuring the difference between the predicted phases and ground truth labels. While described with reference to a contrastive temporal distance pretext task, it should be understood that a foundation model trained for any or all of the pretext tasks described above may be retrained/fine-tuned for phase recognition.

At block 1122, the foundation model is optionally applied for one or more downstream tasks associated with the at least one pretext task. For instance, the foundation model may be applied for an image segmentation task. Real-time medical data including the one or more frames may be input into the foundation model trained for semantic segmentation and the trained foundation model may generate segmented images. The trained foundation model may encode a frame of video data into a lower-dimensional vector representation (e.g., a vector representation of features included in the input data) using an encoder. The trained foundation model may decode the lower-dimensional vector representation back to its original dimensionality, producing a pixel-wise prediction/segmentation map, assigning labels to the pixels in the image. The foundation model may identify objects in the input frame, generate overlays (e.g., masks) that are displayed over the original input frame, etc., that may be displayed to a user (e.g., a physician) to enable more efficient and effective treatment during a medical procedure. In some examples, training the foundation model for image segmentation may include training the foundation model to identify types of lesions (or other objects) in a body during surgery and generate image overlays identifying the lesions. Labels generated by the foundation model may be applied to image data of the surgery and displayed to a user (e.g., a physician) to assist with diagnosis and treatment during the surgery.

In some examples, the foundation model may be applied for an action recognition task. Real-time medical data may be input into the foundation model trained for action recognition and the trained foundation model may predict action classifications. For instance, the trained foundation model may encode a frame of video data into a lower-dimensional vector representation (e.g., a vector representation of features included in the input data) using an encoder. The lower-dimensional vector representation may capture spatial and temporal features included in the input data. The trained foundation model may analyze the lower-dimensional vector representation or sequences of lower-dimensional vector representations obtained from the input data to predict action classifications. The foundation model may track predicted actions in a surgical log, compare predicted actions to expected actions at different times during a procedure to detect anomalies (e.g., unexpected or improper actions), generate and display alerts when anomalies are detected, recommend next steps following a detected anomaly, etc.

In some examples, the foundation model may be applied for a phase recognition task. Real-time medical data may be input into the foundation model trained for action recognition and the trained foundation model may predict phase classifications. For instance, the trained foundation model may encode a frame of video data into a lower-dimensional vector representation (e.g., a vector representation of features included in the input data) using an encoder. The lower-dimensional vector representation may capture spatial and temporal features included in the input data. The trained foundation model may analyze the lower-dimensional vector representation or sequences of lower-dimensional vector representations obtained from the input data to predict phase classifications. The foundation model may track predicted phases in a surgical log, compare predicted phases to expected phases at different times during a procedure to detect anomalies (e.g., unexpected or improper actions), generate and display alerts when anomalies are detected, recommend next steps following a detected anomaly, etc.

In some examples, the foundation model trained for the pretext task may be used for one or more downstream tasks without retraining the foundation model at block 1122. For instance, in some examples, the downstream task may be the same as the pretext task. In some examples, the downstream task may include predicting/reconstructing an image quality or an image resolution. In some examples where the foundation model was trained for an image reconstruction pretext task, including reconstructing an image quality, the trained foundation model may be used to reconstruct image quality of real-time video data during a medical procedure. The real-time medical video data (e.g., of a surgical procedure) may include one or more low-quality frames. The real-time medical video data including the one or more low-quality frames may be input into the trained foundation model and the trained foundation model may generate reconstructed high-quality frames. For instance, the trained foundation model may encode a low-quality frame into a lower-dimensional vector representation using an encoder and may generate a high-quality frame based on the lower-dimensional vector representation using a decoder. The generated high-quality frames can then be displayed to a user (e.g., a physician) during the medical procedure, enabling efficient treatment, improved patient outcomes, etc.

In some examples where the foundation model was trained for an image reconstruction pretext task including reconstructing an image resolution, the trained foundation model may be used to reconstruct image resolution of real-time video data during a medical procedure. The real-time medical video data (e.g., of a surgical procedure) may include one or more low-resolution frames. The real-time medical video data including the one or more low-resolution frames may be input into the trained foundation model and the trained foundation model may generate high-resolution frames. For instance, the trained foundation model may encode a low-resolution frame into a lower-dimensional vector representation using an encoder and may generate a high-resolution frame (e.g., higher resolution than the input) based on the lower-dimensional vector representation using a decoder. The generated high-resolution frames can then be displayed to a user (e.g., a physician) during the medical procedure, enabling efficient treatment, improved patient outcomes, etc.

Method 1100 is performed, for example, using one or more electronic devices implementing a software platform. In some examples, method 1100 is performed using one or more electronic devices, for instance, using one or more devices included in system 100 shown in FIG. 1A and/or system 300 shown in FIG. 3. In some examples, method 1100 is performed using a client-server system, and the blocks of method 1100 are divided up in any manner between the server and one or more client devices. In some examples, method 1100 is performed using a peer-to-peer system (e.g., as described with reference to FIG. 3 above). Thus, while portions of method 1100 are described herein as being performed by particular devices, it will be appreciated that method 1100 is not so limited. In method 1100, some blocks are, optionally, combined, the order of some blocks is, optionally, changed, and some blocks are, optionally, omitted. In some examples, additional steps may be performed in combination with the method 1100. Accordingly, the operations as illustrated (and described in greater detail above) are exemplary by nature and, as such, should not be viewed as limiting.

While the method 1100 is described with reference to a first and a second machine learning model, it should be understood that any number of machine learning models may be received and aggregated from any number of computing devices. The computing devices at which the machine learning models are trained may be located at different sites, such as by using computing devices at different hospitals or different operating rooms within a hospital. The video data and training data may be continuously overwritten during a medical procedure such that all training data is erased following the procedure. However, the model variables including parameters (e.g., weights) and/or gradients of the models can be transmitted to another device, such as a remote server or to the cloud, and may be aggregated to form the foundation model. Accordingly, a robust foundation model can be trained via federated learning without sharing the underlying video/image data from the medical procedure or the training data derived therefrom. Thus, the federated learning example of method 1100 provides a privacy preserving training procedure that captures the technical benefits of federated learning, such as enhanced model accuracy derived from additional training data. In some examples, however, a lower-dimensional vector representation of the video data (e.g., an encoding or an embedding) from each local training site may be saved and sent to a central computing system (e.g., a server) where the foundation model is created by aggregating the locally trained machine learning models. The encodings/embeddings may be used to mitigate model drift resulting from the different training data used at each of the local sites. The encodings/embeddings may be encrypted, would not include patient identifying information, and could not be used to recreate the original video data.

### Example Computing Device

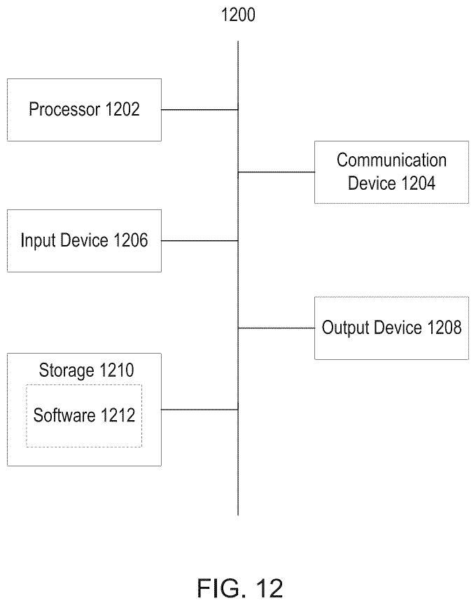

FIG. 12 illustrates an exemplary computing device 1200 that can be used in accordance with one or more examples of the disclosure. Device 1200 can be a client computer or a server. As shown in FIG. 12, device 1200 can be any suitable type of microprocessor-based device, such as a personal computer, workstation, server, or handheld computing device (portable electronic device) such as a phone or tablet. The device can include, for example, one or more of processors 1202, input device 1206, output device 1208, storage 1210, and communication device 1204. Input device 1206 and output device 1208 can generally correspond to those described above and can either be connectable or integrated with the computer.

Input device 1206 can be any suitable device that provides input, such as a touch screen, keyboard or keypad, mouse, or voice-recognition device. Output device 1208 can be any suitable device that provides output, such as a touch screen, haptics device, or speaker.

Storage 1210 can be any suitable device that provides storage, such as an electrical, magnetic, or optical memory, including a RAM, cache, hard drive, or removable storage disk. Communication device 1204 can include any suitable device capable of transmitting and receiving signals over a network, such as a network interface chip or device. The components of the computer can be connected in any suitable manner, such as via a physical bus or wirelessly.

Software 1212, which can be stored in storage 1210 and executed by processor 1202, can include, for example, the programming that embodies the functionality of the present disclosure (e.g., as embodied in the devices as described above). For example, software 1212 can include software for performing one or more steps of method 200 of FIG. 2.

Software 1212 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1210, that can contain or store programming for use by or in connection with an instruction execution system, apparatus, or device.

Software 1212 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1200 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1200 can implement any operating system suitable for operating on the network. Software 1212 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

For the purpose of clarity and a concise description, features are described herein as part of the same or separate examples; however, it will be appreciated that the scope of the disclosure includes examples having combinations of all or some of the features described.

1. A computer implemented method for training a machine learning model based on real-time medical video data from a medical procedure, the method comprising:
obtaining a first portion of the real-time medical video data;
creating first training data for a pretext task, comprising processing the first portion of the real-time medical video data;
training the machine learning model for the pretext task based on the first training data, using a training program of the computer;
obtaining a second portion of the real-time medical video data;
replacing, in a memory of the computer, at least a subset the first portion of the real-time medical video data with the second portion of the real-time medical video data, wherein the memory is accessible only by the training program;
creating second training data for the pretext task, comprising processing the second portion of the real-time medical video data; and
training the machine learning model for the pretext task based on the second training data, using the training program of the computer.

2. The method of claim 1, wherein the first portion of the real-time medical video data and the second portion of the real-time medical video data are inaccessible after the medical procedure ends.

3. The method of claim 1, wherein replacing, in the memory of the computer, the first portion of the real-time medical video data with the second portion of the real-time medical video data comprises: overwriting, in the memory, the first portion of the real-time medical video data with the second portion of the real-time medical video data.

4. The method of claim 1, wherein processing the first portion of the real-time medical video data comprises:
generating first modified data, comprising introducing noise into one or more frames of the first portion of the real-time medical video data, wherein the first training data comprises the first modified data; or
creating one or more frames comprising one or more masked pixels, comprising applying an image mask to one or more frames of the first portion of the real-time medical video data, wherein the first training data comprises the one or more frames comprising one or more masked pixels.

5. The method of claim 1, wherein processing the first portion of the real-time medical video data to create the first training data comprises:
creating one or more low-resolution frames, comprising reducing an image resolution of one or more frames of the first portion of the real-time medical video data, wherein the first training data comprises the one or more low-resolution frames.

6. The method of claim 1, wherein processing the first portion of the real-time medical video data comprises:
creating one or more low-quality frames, comprising reducing an image quality of one or more frames of the first portion of the real-time medical video data, wherein the first training data comprises the one or more low-quality frames; or
creating a temporally modified sequence of frames, comprising rearranging a sequence of frames of the first portion of the real-time medical video data, wherein the first training data comprises the temporally modified sequence of frames.

7. The method of claim 1, wherein processing the first portion of the real-time medical video data comprises:
creating at least one set of temporally adjacent frames and at least one set of temporally distant frames, comprising identifying at least two temporally adjacent frames of a plurality of frames of the first portion of the real-time medical video data and at least two temporally distant frames of the plurality of frames of the first portion of the real-time medical video data, wherein the first training data comprises the at least one set of temporally adjacent frames and the at least one set of temporally distant frames.

8. The method of claim 1, wherein processing the second portion of the real-time medical video data comprises:
generating second modified data, comprising introducing noise into one or more frames from the second portion of the real-time medical video data, wherein the second training data comprises the second modified data; or
creating one or more frames comprising one or more masked pixels, comprising applying an image mask to one or more frames of the second portion of the real-time medical video data, wherein the second training data comprises the one or more frames comprising one or more masked pixels.

9. The method of claim 1, wherein processing the second portion of the real-time medical video data to create the second training data comprises:
creating one or more low-resolution frames, comprising reducing an image resolution of one or more frames of the second portion of the real-time medical video data, wherein the second training data comprises the one or more low-resolution frames.

10. The method of claim 1, wherein processing the second portion of the real-time medical video data comprises:
creating one or more low-quality frames, comprising reducing an image quality of one or more frames of the second portion of the real-time medical video data, wherein the second training data comprises the one or more low-quality frames; or
creating a temporally modified sequence of frames, comprising rearranging a sequence of the frames of the first portion of the real-time medical video data, wherein the second training data comprises the temporally modified sequence of frames.

11. The method of claim 1, wherein processing the first portion of the real-time medical video data comprises:
creating at least one set of temporally adjacent frames and at least one set of temporally distant frames, comprising identifying at least two temporally adjacent frames of a plurality of frames of the second portion of the real-time medical video data and at least two temporally distant frames of the plurality of frames of the second portion of the real-time medical video data, wherein the second training data comprises the at least one set of temporally adjacent frames and the at least one set of temporally distant frames.

12. The method of claim 1, further comprising: retraining the machine learning model using labeled image data for one or more downstream tasks associated with the pretext task, wherein the labeled image data for the one or more downstream tasks associated with the pretext task comprises labeled surgical image data obtained during a surgical procedure.

13. The method of claim 1, further comprising: retraining the machine learning model using labeled image data for one or more downstream tasks associated with the pretext task, wherein the one or more downstream tasks comprises:
a semantic segmentation downstream task, wherein the semantic segmentation downstream task comprises detecting one or more anatomical features in image data of a surgical procedure,
wherein the semantic segmentation downstream task is associated with an image reconstruction pretext task.

14. The method of claim 1, further comprising: retraining the machine learning model using labeled image data for one or more downstream tasks associated with the pretext task, wherein the one or more downstream tasks comprises:
an action recognition downstream task, wherein the action recognition downstream task comprises classifying an action detected based on image data of a surgical procedure,
wherein the action recognition downstream task is associated with an event sequencing pretext task.

15. The method of claim 1, further comprising: retraining the machine learning model using labeled image data for one or more downstream tasks associated with the pretext task, wherein the one or more downstream tasks comprises:
a phase recognition downstream task, wherein the phase recognition task comprises classifying a surgical procedure phase based on image data of a surgical procedure,
wherein the phase recognition downstream task is associated with a contrastive temporal distance pretext task.

16. The method of claim 1, comprising:
inputting real-time medical video data into the machine learning model trained for the pretext task;
generating an output, comprising enhancing at least one of a resolution and a quality of the real-time medical video data; and
causing display of the output.

17. The method of claim 1, wherein the machine learning model is trained using federated machine learning.

18. A system for training a machine learning model based on real-time medical video data from a medical procedure, the system comprising one or more processors and a memory storing one or more programs that include instructions executable by the one or more processors for causing the system to:
obtain a first portion of the real-time medical video data;
create first training data for a pretext task, comprising processing the first portion of the real-time medical video data;
train the machine learning model for the pretext task based on the first training data, using a training program;
obtain a second portion of the real-time medical video data;
replace, in a memory of the system, at least a subset the first portion of the real-time medical video data with the second portion of the real-time medical video data, wherein the memory is accessible only by the training program;
create second training data for the pretext task, comprising processing the second portion of the real-time medical video data; and
train the machine learning model for the pretext task based on the second training data, using the training program.

19. A non-transitory computer-readable storage medium storing instructions for training a machine learning model based on real-time medical video data from a medical procedure, the instructions executable by a system comprising one or more processors to cause the system to:
obtain a first portion of the real-time medical video data;
create first training data for a pretext task, comprising processing the first portion of the real-time medical video data;
train the machine learning model for the pretext task based on the first training data, using a training program;
obtain a second portion of the real-time medical video data;
replace, in a memory of the system, at least a subset the first portion of the real-time medical video data with the second portion of the real-time medical video data, wherein the memory is accessible only by the training program;
create second training data for the pretext task, comprising processing the second portion of the real-time medical video data; and
train the machine learning model for the pretext task based on the second training data, using the training program.

20. The non-transitory computer-readable storage medium of claim 19, wherein the instructions cause the system to:
train the machine learning model using federated machine learning.
